(19) United States
(12) Patent Application Publication
(10) Pub. No.: US 2025/0219897 A1
(43) Pub. Date: Jul. 3, 2025

(54) FEATURE DISCOVERY IN NON-DIRECT SUBSCRIPTION SCENARIOS

(71) Applicant: Telefonaktiebolaget LM Ericsson (publ), Stockholm (SE)

(72) Inventors: Wenliang XU, Shanghai (CN); Susana FERNANDEZ ALONSO, Madrid (ES); Fuencisla GARCIA AZORERO, Madrid (ES); Jesus Angel DE GREGORIO RODRIGUEZ, Boadilla Del Monte, Madrid (ES)

(21) Appl. No.: 18/876,524

(22) PCT Filed: Jun. 12, 2023
(86) PCT No.: PCT/CN2023/099607

§ 371 Date: Dec. 18, 2024

(30) Foreign Application Priority Data
Jun. 29, 2022 (WO) PCT/CN2022/102184

(51) Int. Cl. H04L 41/0686; H04L 41/0894

(52) U.S. Cl. CPC H04L 41/0686; H04L 41/0894

(57) ABSTRACT

The present disclosure is related to methods and network nodes for feature discovery in non-direct subscription scenarios. A method at a first network node for determining whether one or more first features are to be used for notification from the first network node to a second network node or not is provided. The notification is subscribed by a non-direct subscription operation. The method includes: receiving information indicating whether the one or more first features are supported by the second network node or information from which whether the one or more first features are supported by the second network node is able to be derived; and determining whether the one or more first features are to be used for the notification based on at least the received information.

### CROSS-REFERENCE TO RELATED APPLICATION(S)

This application claims priority to the PCT International Application No. PCT/CN2022/102184, entitled “FEATURE DISCOVERY IN NON-DIRECT SUBSCRIPTION SCENARIOS”, filed on Jun. 29, 2022, which is incorporated herein by reference in its entirety.

### TECHNICAL FIELD

The present disclosure is related to the field of telecommunication, and in particular, to methods and network nodes for feature discovery in non-direct subscription scenarios.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient telecommunication system is needed, such as a fifth generation system (5GS), will be required.

Third Generation Partnership Project (3GPP) 5th Generation (5G) supports a discovery mechanism that enables Core Network (CN) entities to discover a set of Network Function (NF) instance(s) and NF service instance(s) for a specific NF service or an NF type. Unless the expected NF and NF service information is locally configured in the requester NF, the NF and NF service discovery is implemented via the Network Repository Function (NRF).

In order for the requested NF type or NF service to be discovered via the NRF, the NF instance needs to be registered in the NRF.

3GPP 5G CN also supports a mechanism to negotiate applicable optional features for each 5G Application Programming Interface (API). Both NF service consumer and NF service producer can directly negotiate the support of optional features as part of the interface. Most of 5G Service Based Interfaces (SBIs) negotiate the support of optional functionality when the NF Service Consumer firstly contact the NF Service Producer for the resource creation as specified in subclause 6.6 of 3GPP Technical Specification (TS) 29.500, V17.6.0. The NF service consumer may also negotiate the supported features as part of the data retrieval operation, fetching the supported features associated to the resource.

Additionally, as stated in 3GPP TS 29.500, V17.6.0, “a NF instance should register all the features it supports to the NRF, to enable NF Service Consumers to discover NF Service Producers supporting specific features. An NF instance should register all the features it supports as NF Service Consumer in the corresponding default notification subscription in its NF profile to the NRF, to enable NF Service Producer to select NF Service Consumer supporting specific features”.

5G Core Networks also allow that Service consumer NFs can explicitly or implicitly subscribe to be notified about data change to any type of resource. Subscriptions may be implicit, i.e., exist without being explicitly created by a dedicated subscribe operation (see TS 29.501, V17.5.0, clause 4.6.2.2.1). There are two types of implicit subscription:
1. where an explicit operation exists (e.g. Npcf_SMPolicyControl_Create), and the corresponding notifications are part of the same service procedures (e.g. Npcf_SMPolicy_Update, notifying about matched events), and
2. where the subscription exists without any explicit operation. For example, at the Unified Data Repository (UDR), any available Unified Data Management (UDM) is implicitly subscribed to notification about changes of provisioned data; the UDR selects one of the suitable available UDMs (as discovered via the NRF, considering the UDM supported features) and sends a notification using the callback Uniform Resource Identifier (URI) provided by the NRF during UDM discovery.

### SUMMARY

There are also other kinds of subscriptions where the NF provider subscribes using a different service and a different path than the one used in the requested notification. Some other examples of the subscription applicable to this case related to Policy & Charging Control (PCC) functionality are shown here:
Application Function (AF) may send requests to influence Session Management Function (SMF) routing decisions for User Plane traffic of Protocol Data Unit (PDU) Sessions as described in 3GPP TS 29.513, V17.6.0, clause 5.5.3. In this case the AF uses the PCC framework (either directly via Policy Control Function (PCF) or using the Network Exposure Function (NEF) & UDR when non targeting individual User Equipment (UE) addresses) to indicate its request subscriptions to SMF events, e.g. User Plane (UP) path change. SMF receives the subscription information provisioned in the PCC rule, i.e. the event and the AF/NEF notification URI. SMF will directly notify the AF (via NEF for external applications).
AF may provision service parameter data to the PCF that could generate UE Route Selection Policy (URSP) Rules towards the UE. Additionally, the AF may subscribe to receive notifications on URSP Rules delivery outcome. The AF subscription is indicated to the PCF as service parameter data stored in the UDR, i.e., the event and the AF/NEF notification URI.

In these cases, the NF that requires to be notified needs to provide the event together with a Notification URI through the PCC framework. The Notification URI indicates the final receiver of the event notification.

However, there is currently no mechanism to negotiate features to be used in non-direct subscribed notification between the involved parties.

To solve or at least partially alleviate this problem, some embodiments of the present disclosure are provided below.

According to a first aspect of the present disclosure, a method at a first network node for determining whether one or more first features are to be used for notification from the first network node to a second network node or not is provided. The notification is subscribed by a non-direct subscription operation. The method comprises: receiving information indicating whether the one or more first features are supported by the second network node or information from which whether the one or more first features are supported by the second network node is able to be derived; and determining whether the one or more first features are to be used for the notification based on at least the received information.

In some embodiments, the non-direct subscription operation is a first service operation, which is associated with a first service and which is invoked by a third network node in response to a second service operation associated with a second service being invoked by the second network node. In some embodiments, the first service is different from the second service. In some embodiments, the third network node is different from the second network node. In some embodiments, at least one of the first service and the second service is provided by the third network node.

In some embodiments, the step of receiving the information comprises at least one of: receiving, from the third network node, a first message indicating a notification URI, which points to the second network node; receiving, from the third network node, a first message indicating an NF instance identifier (ID) of the second network node; and receiving, from the third network node, a first message indicating zero or more second features supported by the second network node as an NF service consumer.

In some embodiments, when the first message indicates the notification URI pointing to the second network node, the step of determining whether the one or more first features are to be used for the notification comprises: transmitting, to a fourth network node, a second message for discovering an NF instance that has a notification URI in its NF profile matched with the notification URI and that supports, as an NF service consumer, the one or more first features required by the first network node; and/or receiving, from the fourth network node, a third message indicating zero or one NF instance in response to the second message. In some embodiments, the step of determining whether the one or more first features are to be used for the notification further comprises at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type. In some embodiments, when the second message further indicates the first notification type, the step of determining whether the one or more first features are to be used for the notification further comprises at least one of: determining that the one or more first features are to be used for the notification at least in response to receiving, from the fourth network node, the third message indicating one NF instance; and determining that the one or more first features are not to be used for the notification at least in response to receiving, from the fourth network node, the third message indicating no NF instance.

In some embodiments, when the first message indicates the notification URI pointing to the second network node, the step of determining whether the one or more first features are to be used for the notification comprises: transmitting, to a fourth network node, a second message for discovering an NF instance that has a notification URI in its NF profile matched with the notification URI; and/or receiving, from the fourth network node, a third message indicating zero or one NF instance in response to the second message, wherein when one NF instance is indicated by the third message, the third message further indicates, for the indicated NF instance and for each of notification types indicated by the third message, zero or more second features supported by the indicated NF instance as an NF service consumer. In some embodiments, the step of determining whether the one or more first features are to be used for the notification further comprises at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the notification URI pointing to the second network node, the step of determining whether the one or more first features are to be used for the notification comprises: transmitting, to a fourth network node, a second message for discovering an NF instance that has a notification URI in its NF profile matched with the notification URI and associated to a first notification type, the first notification type indicating that the notification is subscribed by a non-direct subscription operation; and/or receiving, from the fourth network node, a third message indicating zero or one NF instance in response to the second message, wherein when one NF instance is indicated by the third message, the third message further indicates, for the indicated NF instance and for the first notification type, zero or more second features supported by the indicated NF instance as an NF service consumer. In some embodiments, the step of determining whether the one or more first features are to be used for the notification further comprises at least one of: determining that the one or more first features are to be used for the notification at least in response to receiving, from the fourth network node, the third message indicating one NF instance and in response to determining that the one or more first features are one or more of the zero or more second features; and determining that the one or more first features are not to be used for the notification at least in response to receiving, from the fourth network node, the third message indicating no NF instance or in response to, when the third message indicates one NF instance, determining that the one or more first features are not one or more of the zero or more second features.

In some embodiments, when the first message indicates the NF instance ID of the second network node, the step of determining whether the one or more first features are to be used for the notification comprises: transmitting, to a fourth network node, a second message for discovering an NF instance that has an NF instance ID indicated in the first message and that supports, as an NF service consumer, the one or more first features required by the first network node; and/or receiving, from the fourth network node, a third message indicating zero or one NF instance in response to the second message. In some embodiments, the step of determining whether the one or more first features are to be used for the notification further comprises at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the NF instance ID of the second network node, the step of determining whether the one or more first features are to be used for the notification comprises: transmitting, to a fourth network node, a second message for discovering an NF instance that has an NF instance ID indicated in the first message; and/or receiving, from the fourth network node, a third message indicating zero or one NF instance in response to the second message, wherein when one NF instance is indicated by the third message, the third message further indicates, for the indicated NF instance and for each of notification types indicated by the third message, zero or more second features supported by the indicated NF instance as an NF service consumer. In some embodiments, the step of determining whether the one or more first features are to be used for the notification further comprises at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the zero or more second features supported by the second network node as an NF service consumer, the step of determining whether the one or more first features are to be used for the notification comprises at least one of: determining that the one or more first features are to be used for the notification at least in response to determining that the zero or more second features supported by the second network node comprise the one or more first features; and determining that the one or more first features are not to be used for the notification at least in response to determining that the zero or more second features supported by the second network node do not comprise the one or more first features.

In some embodiments, before the step of determining whether the one or more first features are to be used for the notification, the method further comprises: transmitting, to the fourth network node, a fourth message indicating at least one of: a notification URI pointing to the first network node and associated to a first notification type, the first notification type indicating that the notification is subscribed by a non-direct subscription operation, zero or more third features supported by the first network node as an NF service producer, and an NF instance ID of the first network node.

In some embodiments, the method further comprises: transmitting, to the second network node, a fifth message as the notification, with the one or more first features used based on at least the determination of whether the one or more first features are to be used for the notification. In some embodiments, the fifth message further indicates at least one of: a notification URI pointing to the first network node; an NF instance ID of the first network node; and zero or more third features supported by the first network node as an NF service producer.

In some embodiments, at least one of following is true: the first network node is an SMF; the second network node is a NEF or AF; the third network node is a PCF; the fourth network node is a NRF; the first message is an Npcf_SMPolicyControl_UpdateNotify request message; the second message is an Nnrf_NFDiscovery_Request request message; the third message is an Nnrf_NFDiscovery_Request response message; the fourth message is an Nnrf_NFManagement_NFRegister request message; and the fifth message is an Nsmf_EventExposure_Notify request message.

According to a second aspect of the present disclosure, a first network node is provided. The first network node comprises: a processor; a memory storing instructions which, when executed by the processor, cause the processor to perform any of the methods of the first aspect. In some embodiments, an SMF is deployed at the first network node.

According to a third aspect of the present disclosure, a first network node for determining whether one or more first features are to be used for notification from the first network node to a second network node or not is provided. The notification is subscribed by a non-direct subscription operation. The first network node comprises: a receiving module configured to receive information indicating whether the one or more first features are supported by the second network node or information from which whether the one or more first features are supported by the second network node is able to be derived; and a determining module configured to determine whether the one or more first features are to be used for the notification based on at least the received information. In some embodiments, the first network node further comprises one or more modules configured to perform any steps of any of the methods of the first aspect.

According to a fourth aspect of the present disclosure, a method at a second network node for facilitating a first network node in determining whether one or more first features are to be used for notification from the first network node to the second network node or not is provided. The notification is subscribed by a non-direct subscription operation. The method comprises: transmitting, to a third network node different from the first network node, information indicating whether the one or more first features are supported by the second network node or information from which whether the one or more first features are supported by the second network node is able to be derived.

In some embodiments, the non-direct subscription operation is a first service operation, which is associated with a first service and which is invoked by the third network node in response to a second service operation associated with a second service being invoked by the second network node. In some embodiments, the first service is different from the second service. In some embodiments, the third network node is different from the second network node. In some embodiments, at least one of the first service and the second service is provided by the third network node. In some embodiments, the step of transmitting the information comprises at least one of: transmitting, to the third network node, a sixth message indicating a notification URI, which points to the second network node; transmitting, to the third network node, a sixth message indicating an NF instance ID of the second network node; and transmitting, to the third network node, a sixth message indicating zero or more second features supported by the second network node as an NF service consumer.

In some embodiments, before the step of transmitting the information, the method further comprises: transmitting, to a fourth network node, a seventh message indicating at least one of: a notification URI pointing to the second network node and associated to a first notification type indicating that the notification is subscribed by a non-direct subscription operation, one or more second features supported by the second network node as an NF service consumer, and an NF instance ID of the second network node. In some embodiments, the method further comprises: receiving, from the first network node, a fifth message as the notification, with the one or more first features used based on at least the information transmitted to the third network node. In some embodiments, the fifth message further indicates at least one of: another notification URI pointing to the first network node; an NF instance ID of the first network node; and zero or more third features supported by the first network node as an NF service producer.

In some embodiments, when the fifth message indicates the other notification URI pointing to the first network node, the method further comprises: transmitting, to a fourth network node, an eighth message for discovering an NF instance that has a notification URI in its NF profile matched with the other notification URI and that supports, as an NF service producer, one or more fourth features required by the second network node; and/or receiving, from the fourth network node, a ninth message indicating zero or one NF instance in response to the eighth message. In some embodiments, the method further comprises at least one of: determining that the one or more fourth features are to be used for another notification from the second network node to the first network node at least in response to receiving, from the fourth network node, the ninth message indicating one NF instance; and determining that the one or more fourth features are not to be used for the other notification at least in response to receiving, from the fourth network node, the ninth message indicating no NF instance.

In some embodiments, when the fifth message indicates the other notification URI pointing to the first network node, the method further comprises: transmitting, to a fourth network node, an eighth message for discovering an NF instance that has a notification URI in its NF profile matched with the other notification URI; and/or receiving, from the fourth network node, a ninth message indicating zero or one NF instance in response to the eighth message, wherein when one NF instance is indicated by the ninth message, the ninth message further indicates, for the indicated NF instance, zero or more third features supported by the indicated NF instance as an NF service producer. In some embodiments, the method further comprises at least one of: determining that the one or more fourth features are to be used for another notification from the second network node to the first network node at least in response to receiving, from the fourth network node, the ninth message indicating one NF instance and in response to determining that the one or more fourth features are one or more of the zero or more third features; and determining that the one or more fourth features are not to be used for the other notification at least in response to receiving, from the fourth network node, the ninth message indicating no NF instance or in response to, when the ninth message indicates one NF instance, determining that the one or more fourth features are not one or more of the zero or more third features.

In some embodiments, when the fifth message indicates the NF instance ID of the first network node, the method further comprises: transmitting, to a fourth network node, an eighth message for discovering an NF instance that has an NF instance ID indicated in the fifth message and that supports, as an NF service producer, one or more fourth features required by the second network node; and/or receiving, from the fourth network node, a ninth message indicating zero or one NF instance in response to the eighth message. In some embodiments, the method further comprises at least one of: determining that the one or more fourth features are to be used for another notification from the second network node to the first network node at least in response to receiving, from the fourth network node, the ninth message indicating one NF instance; and determining that the one or more fourth features are not to be used for the other notification at least in response to receiving, from the fourth network node, the ninth message indicating no NF instance.

In some embodiments, when the fifth message indicates the NF instance ID of the first network node, the method further comprises: transmitting, to a fourth network node, an eighth message for discovering an NF instance that has an NF instance ID indicated in the fifth message; and/or receiving, from the fourth network node, a ninth message indicating zero or one NF instance in response to the eighth message, wherein when one NF instance is indicated by the ninth message, the ninth message further indicates, for the indicated NF instance, zero or more third features supported by the indicated NF instance as an NF service producer. In some embodiments, the method further comprises at least one of: determining that the one or more fourth features are to be used for another notification from the second network node to the first network node at least in response to receiving, from the fourth network node, the ninth message indicating one NF instance and in response to determining that the one or more fourth features are one or more of the zero or more third features; and determining that the one or more fourth feature are not to be used for the other notification at least in response to receiving, from the fourth network node, the ninth message indicating no NF instance or in response to, when the ninth message indicates one NF instance, determining that the one or more fourth features are not one or more of the zero or more third features.

In some embodiments, when the fifth message indicates the zero or more third features supported by the first network node as an NF service producer, the method further comprises at least one of: determining that one or more fourth features are to be used for another notification from the second network node to the first network node at least in response to determining that the zero or more third features supported by the first network node comprise the one or more fourth features; and determining that the one or more fourth features are not to be used for the other notification at least in response to determining that the zero or more third features supported by the first network node do not comprise the one or more fourth features. In some embodiments, the method further comprises: transmitting, to the first network node, a tenth message as the other notification, with the one or more fourth features used based on at least the determination of whether the one or more fourth features are to be used for the other notification. In some embodiments, at least one of following is true: the first network node is an SMF; the second network node is a NEF or AF; the third network node is a PCF; the fourth network node is an NRF; the fifth message is an Nsmf_EventExposure_Notify request message; the sixth message is an Npcf_PolicyAuthorization_Create request message, an Npcf_PolicyAuthorization_Update request message, or an Npcf_PolicyAuthorization_Delete request message; the seventh message is an Nnrf_NFManagement_NFRegister request message; the eighth message is an Nnrf_NFDiscovery_Request request message; the ninth message is an Nnrf_NFDiscovery_Request response message; and the tenth message is an Nsmf_EventExposure_AppRelocationInfo request message.

According to a fifth aspect of the present disclosure, a second network node is provided. The second network node comprises: a processor; a memory storing instructions which, when executed by the processor, cause the processor to perform the any of the methods of the fourth aspect. In some embodiments, a NEF or AF is deployed at the second network node.

According to a sixth aspect of the present disclosure, a second network node for facilitating a first network node in determining whether one or more first features are to be used for notification from the first network node to the second network node or not is provided. The notification is subscribed by a non-direct subscription operation. The second network node comprises: a transmitting module configured to transmit, to a third network node different from the first network node, information indicating whether the one or more first features are supported by the second network node or information from which whether the one or more first features are supported by the second network node is able to be derived. In some embodiments, the second network node further comprises one or more modules configured to perform any steps of any of the methods of the fourth aspect.

According to a seventh aspect of the present disclosure, a method at a third network node for facilitating a first network node in determining whether one or more first features are to be used for notification from the first network node to a second network node or not is provided. The notification is subscribed by a non-direct subscription operation. The method comprises: forwarding, from the second network node to the first network node, information indicating whether the one or more first features are supported by the second network node or information from which whether the one or more first features are supported by the second network node is able to be derived.

In some embodiments, the non-direct subscription operation is a first service operation, which is associated with a first service and which is invoked by the third network node in response to a second service operation associated with a second service being invoked by the second network node. In some embodiments, the first service is different from the second service. In some embodiments, the third network node is different from the second network node and/or the first network node. In some embodiments, at least one of the first service and the second service is provided by the third network node. In some embodiments, the step of forwarding the information comprises at least one of: receiving, from the second network node, a sixth message indicating a notification URI, which points to the second network node, and transmitting, to the first network node, a first message indicating the notification URI; receiving, from the second network node, a sixth message indicating an NF instance ID of the second network node and transmitting, to the first network node, a first message indicating the NF instance ID; and receiving, from the second network node, a sixth message indicating zero or more second features supported by the second network node as an NF service consumer and transmitting, to the first network node, a first message indicating the zero or more second features. In some embodiments, at least one of following is true: the first network node is an SMF; the second network node is a NEF or AF; the third network node is a PCF; the first message is an Npcf_SMPolicyControl_UpdateNotify request message; and the sixth message is an Npcf_PolicyAuthorization_Create request message, an Npcf_PolicyAuthorization_Update request message, or an Npcf_PolicyAuthorization_Delete request message.

According to an eighth aspect of the present disclosure, a third network node is provided. The third network node comprises: a processor; a memory storing instructions which, when executed by the processor, cause the processor to perform any of the methods of the seventh aspect. In some embodiments, a PCF is deployed at the third network node.

According to a ninth aspect of the present disclosure, a third network node for facilitating a first network node in determining whether one or more first features are to be used for notification from the first network node to a second network node or not is provided. The notification is subscribed by a non-direct subscription operation. The method comprises: a forwarding module configured to forward, from the second network node to the first network node, information indicating whether the one or more first features are supported by the second network node or information from which whether the one or more first features are supported by the second network node is able to be derived. In some embodiments, the third network node further comprises one or more modules configured to perform any steps of any of the methods of the seventh aspect.

According to a tenth aspect of the present disclosure, a method at a fourth network node for facilitating a first network node in determining whether one or more first features are to be used for notification from the first network node to a second network node or not is provided. The notification is subscribed by a non-direct subscription operation. The method comprises: receiving, from the first network node, first information from which whether the one or more first features are supported by the second network node is able to be derived; determining second information indicating whether the one or more first features are supported by the second network node based on at least the first information; and transmitting, to the first network node, the second information.

In some embodiments, the non-direct subscription operation is a first service operation, which is associated with a first service and which is invoked by a third network node in response to a second service operation associated with a second service being invoked by the second network node. In some embodiments, the first service is different from the second service. In some embodiments, the third network node is different from the second network node and/or the first network node. In some embodiments, at least one of the first service and the second service is provided by the third network node. In some embodiments, the first information comprises at least one of: information indicating a notification URI pointing to the second network node; information indicating an NF instance ID of the second network node; information indicating the one or more first features; and information indicating a first notification type, which indicates that the notification is subscribed by a non-direct subscription operation.

In some embodiments, the step of receiving the first information comprises: receiving, from the first network node, a second message for discovering an NF instance that has a notification URI in its NF profile matched with the notification URI and that supports, as an NF service consumer, the one or more first features required by the first network node, and/or wherein the step of determining the second information comprises: determining, from one or more NF instances registered at the fourth network node, zero or one NF instance that has a notification URI in its NF profile matched with the notification URI and that supports, as an NF service consumer, the one or more first features, and/or wherein the step of transmitting the second information comprises: transmitting, to the first network node, a third message indicating the zero or one NF instance, and/or wherein when one NF instance is determined and indicated in the third message, the third message further indicates, for each of notification types which are registered by the indicated NF instance at the fourth network node, zero or more second features that are supported by the indicated NF instance as an NF service consumer.

In some embodiments, the step of receiving the first information comprises: receiving, from the first network node, a second message for discovering an NF instance that has a notification URI in its NF profile matched with the notification URI and associated to the first notification type and that supports, as an NF service consumer, the one or more first features required by the first network node and associated to the first notification type, and/or wherein the step of determining the second information comprises: determining, from one or more NF instances registered at the fourth network node, zero or one NF instance that has a notification URI in its NF profile matched with the notification URI and associated to the first notification type and that supports, as an NF service consumer, the one or more first features associated to the first notification type, and/or wherein the step of transmitting the second information comprises: transmitting, to the first network node, a third message indicating the zero or one NF instance.

In some embodiments, the step of receiving the first information comprises: receiving, from the first network node, a second message for discovering an NF instance that has a notification URI in its NF profile matched with the notification URI, and/or wherein the step of determining the second information comprises: determining, from one or more NF instances registered at the fourth network node, zero or one NF instance that has a notification URI in its NF profile matched with the notification URI, and/or wherein the step of transmitting the second information comprises: transmitting, to the first network node, a third message indicating the zero or one NF instance, and/or wherein when one NF instance is determined and indicated by the third message, the third message further indicates, for each of notification types which are registered by the indicated NF instance at the fourth network node, zero or more second features supported by the indicated NF instance as an NF service consumer.

In some embodiments, the step of receiving the first information comprises: receiving, from the first network node, a second message for discovering an NF instance that has a notification URI in its NF profile matched with the notification URI and associated to the first notification type, and/or wherein the step of determining the second information comprises: determining, from one or more NF instances registered at the fourth network node, zero or one NF instance that has a notification URI in its NF profile matched with the notification URI and associated to the first notification type, and/or wherein the step of transmitting the second information comprises: transmitting, to the first network node, a third message indicating the zero or one NF instance, and/or wherein when one NF instance is determined and indicated by the third message, the third message further indicates, for the first notification type, zero or more second features supported by the indicated NF instance as an NF service consumer.

In some embodiments, the step of receiving the first information comprises: receiving, from the first network node, a second message for discovering an NF instance that has an NF instance ID of the second network node and that supports, as an NF service consumer, the one or more first features required by the first network node, and/or wherein the step of determining the second information comprises: determining, from one or more NF instances registered at the fourth network node, zero or one NF instance that has an NF instance ID indicated in the second message and that supports, as an NF service consumer, the one or more first features, and/or wherein the step of transmitting the second information comprises: transmitting, to the first network node, a third message indicating the zero or one NF instance, and/or wherein when one NF instance is determined and indicated in the third message, the third message further indicates, for each of notification types which are registered by the indicated NF instance at the fourth network node, zero or more second features supported by the indicated NF instance as an NF service consumer.

In some embodiments, the step of receiving the first information comprises: receiving, from the first network node, a second message for discovering an NF instance that has an NF instance ID indicated in the first message, and/or wherein the step of determining the second information comprises: determining, from one or more NF instances registered at the fourth network node, zero or one NF instance that has an NF instance ID indicated in the second message, and/or wherein the step of transmitting the second information comprises: transmitting, to the first network node, a third message indicating zero or one NF instance in response to the second message, and/or wherein when one NF instance is determined and indicated by the third message, the third message further indicates, for each of notification types which are registered by the indicated NF instance at the fourth network node, zero or more second features supported by the indicated NF instance as an NF service consumer.

In some embodiments, before the step of receiving the first information, the method further comprises at least one of: receiving, from the first network node, a fourth message indicating at least one of a notification URI pointing to the first network node and associated to the first notification type, zero or more third features supported by the first network node as an NF service producer, and an NF instance ID of the first network node; and receiving, from the second network node, a seventh message indicating at least one of a notification URI pointing to the second network node and associated to the first notification type, one or more second features supported by the second network node as an NF service consumer, and an NF instance ID of the second network node.

In some embodiments, the method further comprises: receiving, from the second network node, third information from which whether one or more fourth features are supported by the first network node is able to be derived; and/or determining fourth information indicating whether the one or more fourth features are supported by the first network node based on at least the third information; and/or transmitting, to the second network node, the fourth information. In some embodiments, the third information comprises at least one of: information indicating another notification URI pointing to the first network node; information indicating an NF instance ID of the first network node; information indicating the one or more fourth features; and information indicating a first notification type, which indicates that the notification is subscribed by a non-direct subscription operation. In some embodiments, the step of receiving the third information comprises: receiving, from the second network node, an eighth message for discovering an NF instance that has a notification URI in its NF profile matched with the other notification URI and that supports, as an NF service producer, the one or more fourth features required by the second network node, and/or wherein the step of determining the fourth information comprises: determining, from one or more NF instances registered at the fourth network node, zero or one NF instance that has a notification URI in its NF profile matched with the other notification URI and that supports, as an NF service producer, the one or more fourth features, and/or wherein the step of transmitting the fourth information comprises: transmitting, to the second network node, a ninth message indicating the zero or one NF instance.

In some embodiments, the step of receiving the third information comprises: receiving, from the second network node, an eighth message for discovering an NF instance that has a notification URI in its NF profile matched with the other notification URI, and/or wherein the step of determining the fourth information comprises: determining, from one or more NF instances registered at the fourth network node, zero or one NF instance that has a notification URI in its NF profile matched with the other notification URI, and/or wherein the step of transmitting the fourth information comprises: transmitting, to the second network node, a ninth message indicating zero or one NF instance, and/or wherein when one NF instance is determined and indicated by the ninth message, the ninth message further indicates zero or more third features supported by the indicated NF instance as an NF service producer.

In some embodiments, the step of receiving the third information comprises: receiving, from the second network node, an eighth message for discovering an NF instance that has an NF instance ID of the first network node and that supports, as an NF service producer, the one or more fourth features required by the second network node, and/or wherein the step of determining the fourth information comprises:

determining, from one or more NF instances registered at the fourth network node, zero or one NF instance that has an NF instance ID of the first network node and that supports, as an NF service producer, the one or more fourth features, and/or wherein the step of transmitting the fourth information comprises: transmitting, to the second network node, a ninth message indicating the zero or one NF instance.

In some embodiments, the step of receiving the third information comprises: receiving, from the second network node, an eighth message for discovering an NF instance that has an NF instance ID of the first network node, and/or wherein the step of determining the fourth information comprises: determining, from one or more NF instances registered at the fourth network node, zero or one NF instance that has an NF instance ID of the first network node, and/or wherein the step of transmitting the fourth information comprises: transmitting, to the second network node, a ninth message indicating zero or one NF instance, and/or wherein when one NF instance is determined and indicated by the ninth message, the ninth message further indicates zero or more third features supported by the indicated NF instance as an NF service producer.

In some embodiments, at least one of following is true: the first network node is an SMF; the second network node is a NEF or AF; the fourth network node is an NRF; the second message is an Nnrf_NFDiscovery_Request request message; the third message is an Nnrf_NFDiscovery_Request response message; the fourth message is an Nnrf_NFManagement_NFRegister request message; the seventh message is an Nnrf_NFManagement_NFRegister request message; the eighth message is an Nnrf_NFDiscovery_Request request message; and the ninth message is an Nnrf_NFDiscovery_Request response message.

According to an eleventh aspect of the present disclosure, a fourth network node is provided. The fourth network node comprises: a processor; a memory storing instructions which, when executed by the processor, cause the processor to perform any of the methods of the tenth aspect. In some embodiments, an NRF is deployed at the fourth network node.

According to a twelfth aspect of the present disclosure, a fourth network node for facilitating a first network node in determining whether one or more first features are to be used for notification from the first network node to a second network node or not is provided. The notification is subscribed by a non-direct subscription operation. The fourth network node comprises: a receiving module configured to receive, from the first network node, first information from which whether the one or more first features are supported by the second network node is able to be derived; a determining module configured to determine second information indicating whether the one or more first features are supported by the second network node based on at least the first information; and a transmitting module configured to transmit, to the first network node, the second information. In some embodiments, the fourth network node further comprises one or more modules configured to perform any steps of any of the methods of the tenth aspect.

According to a thirteenth aspect of the present disclosure, a computer program comprising instructions is provided. The instructions, when executed by at least one processor, cause the at least one processor to carry out any of the methods of any of the first, fourth, seventh, and tenth aspects.

According to a fourteenth aspect of the present disclosure, a carrier containing the computer program of the thirteenth aspect is provided. In some embodiments, the carrier is one of an electronic signal, optical signal, radio signal, or computer readable storage medium.

According to a fifteenth aspect of the present disclosure, a telecommunication system for determining whether one or more first features are to be used for notification from a first network node to a second network node or not is provided. The notification is subscribed by a non-direct subscription operation. The telecommunication system comprises: the second network node configured to transmit, to a third network node, second information indicating whether one or more first features are supported by the second network node or first information from which whether the one or more first features are supported by the second network node is able to be derived; the third network node configured to forward, from the second network node to a first network node, the second information indicating whether the one or more first features are supported by the second network node or the first information from which whether the one or more first features are supported by the second network node is able to be derived; the first network node configured to: receive the second information indicating whether the one or more first features are supported by the second network node or the first information from which whether the one or more first features are supported by the second network node is able to be derived; and determine whether the one or more first features are to be used for the notification based on at least the received information.

In some embodiments, when the first network node is configured to receive the first information, the telecommunication system further comprises: a fourth network node configured to: receive, from the first network node, the first information;

determine the second information based on at least the first information; and transmit, to the first network node, the second information. In some embodiments, at least one of following is true: the first network node is a first network node of the second or third aspect; the second network node is a second network node of the fifth or sixth aspect; the third network node is a third network node of the eighth or ninth aspect; and the fourth network node is a fourth network node of the eleventh or twelfth aspect.

With some embodiments of the present disclosure, features to be used in non-direct subscribed notification can be negotiated or otherwise determined between the involved parties. For example, network functions may be allowed to determine one or more features to be used in a notification to an already selected NF (service) instance, based on a non-direct subscription that occurred via a different path than the one used to report notification, using different services than those used in the notification or based on a previous notification to be aware of the features that the receiver of the notification supports.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a block diagram illustrating an exemplary telecommunication network in which feature discovery in non-direct subscription scenarios according to an embodiment of the present disclosure may be applicable.

FIG. 2A and FIG. 2B are diagrams illustrating an exemplary procedure in which feature discovery in non-direct subscription scenarios according to an embodiment of the present disclosure may be applicable.

FIG. 3A through FIG. 3C are diagrams illustrating an exemplary procedure for feature discovery in non-direct subscription scenarios according to an embodiment of the present disclosure.

FIG. 4A through FIG. 4C are diagrams illustrating another exemplary procedure for feature discovery in non-direct subscription scenarios according to another embodiment of the present disclosure.

FIG. 5A and FIG. 5B are diagrams illustrating yet another exemplary procedure for feature discovery in non-direct subscription scenarios according to yet another embodiment of the present disclosure.

FIG. 6 is a flow chart illustrating an exemplary method at a first network node for determining whether one or more first features are to be used for notification from the first network node to a second network node or not according to an embodiment of the present disclosure.

FIG. 7 is a flow chart illustrating an exemplary method at a second network node for facilitating a first network node in determining whether one or more first features are to be used for notification from the first network node to the second network node or not according to an embodiment of the present disclosure.

FIG. 8 is a flow chart illustrating an exemplary method at a third network node for facilitating a first network node in determining whether one or more first features are to be used for notification from the first network node to a second network node or not according to an embodiment of the present disclosure.

FIG. 9 is a flow chart illustrating an exemplary method at a fourth network node for facilitating a first network node in determining whether one or more first features are to be used for notification from the first network node to a second network node or not according to an embodiment of the present disclosure.

FIG. 10 schematically shows an embodiment of an arrangement which may be used in one or more network nodes according to an embodiment of the present disclosure.

FIG. 11 is a block diagram of an exemplary first network node according to an embodiment of the present disclosure.

FIG. 12 is a block diagram of an exemplary second network node according to an embodiment of the present disclosure.

FIG. 13 is a block diagram of an exemplary third network node according to an embodiment of the present disclosure.

FIG. 14 is a block diagram of an exemplary fourth network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, although the following description of some embodiments of the present disclosure is given in the context of 5G system (5GS), the present disclosure is not limited thereto. In fact, as long as feature discovery in non-direct subscription scenarios is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Long Term Evolution (LTE), Evolved Packet System (EPS), 5G New Radio (NR), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an Internet of Things (IoT) device, a vehicle, or any other equivalents. For another example, the term “network node” used herein may refer to a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
3GPP TS 29.500 V17.6.0 (2022 May), Technical Specification, 3rd Generation Partnership Project; Technical Specification Group Core Network and Terminals; 5G System; Technical Realization of Service Based Architecture; Stage 3 (Release 17);
3GPP TS 29.501 V17.5.0 (2022 May), Technical Specification, 3rd Generation Partnership Project; Technical Specification Group Core Network and Terminals; 5G System; Principles and Guidelines for Services Definition; Stage 3 (Release 17);
3GPP TS 29.510 V17.5.0 (2022 May), Technical Specification, 3rd Generation Partnership Project; Technical Specification Group Core Network and Terminals; 5G System; Network Function Repository Services; Stage 3 (Release 17); and
3GPP TS 29.513 V17.6.0 (2022 May), Technical Specification, 3rd Generation Partnership Project; Technical Specification Group Core Network and Terminals; 5G System; Policy and Charging Control signalling flows and QoS parameter mapping; Stage 3 (Release 17).

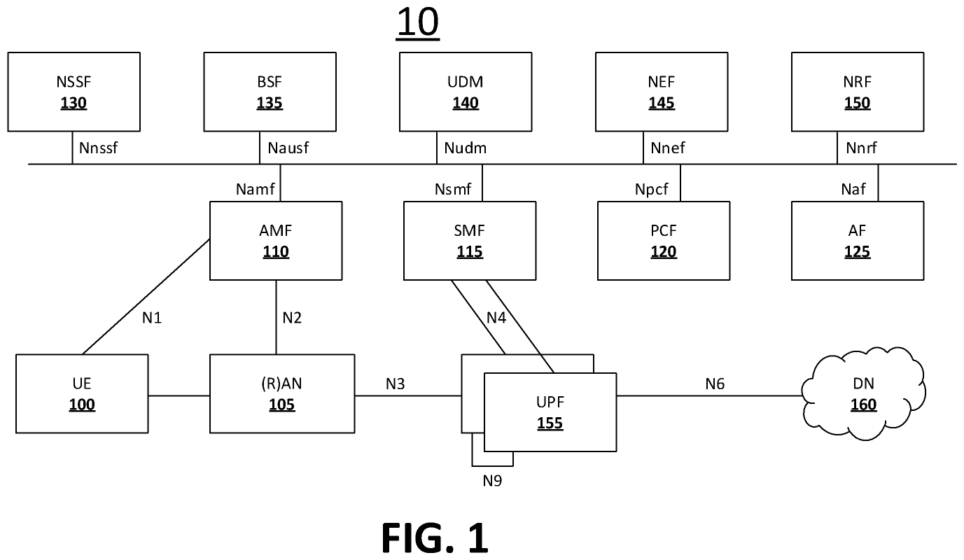

FIG. 1 is a block diagram illustrating an exemplary telecommunication network 10 in which feature discovery in non-direct subscription scenarios according to an embodiment of the present disclosure may be applicable. Although the telecommunication network 10 is a network defined in the context of 5GS, the present disclosure is not limited thereto.

As shown in FIG. 1, the network 10 may comprise one or more UEs 100 and a (radio) access network ((R)AN) 105, which could be a base station, a Node B, an evolved NodeB (eNB), a gNB, or an Access Network (AN) node which provides the UEs 100 with access to other parts of the network 10. Further, the network 10 may comprise its core network portion comprising (but not limited to) an Access and Mobility Management Function (AMF) 110, an SMF 115, a PCF 120, an AF 125, a Network Slice Selection Function (NSSF) 130, a Binding Support Function (BSF) 135, a Unified Data Management (UDM) 140, a NEF 145, a NRF 150, and one or more User Plane Functions (UPFs) 155. As shown in FIG. 1, these entities may communicate with each other via the service-based interfaces, such as, Nnrf, Nsmf, Npcf, etc. and/or the reference points, such as, N1, N2, N3, N4, N6, N9, etc.

However, the present disclosure is not limited thereto. In some other embodiments, the network 10 may comprise additional network functions, less network functions, or some variants of the existing network functions shown in FIG. 1. For example, in a network with the 4G EPS architecture, the entities which perform these functions (e.g., PGW-C) may be different from those shown in FIG. 1 (e.g., the SMF 115). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

As shown in FIG. 1, the UPFs 155 are communicatively connected to the Data Network (DN) 160 which may be, or in turn communicatively connected to, the Internet, such that the UE 100 may finally communicate its user plane data with other devices outside the network 10, for example, via the RAN 105 and the UPFs 155.

Some of the network functions shown in FIG. 1 that may be involved in some embodiments of the present disclosure will be described below.

In some embodiments, the SMF 115 may support (but not limited thereto) at least one of:
Session Management e.g. Session Establishment, modify and release, including tunnel maintain between UPF 155 and AN node 105.
UE IP address allocation & management (including optional Authorization). The UE IP address may be received from a UPF 155 or from an external data network.
Selection and control of User Plane (UP) function, including controlling the UPF 155 to proxy Address Resolution Protocol (ARP) or IPV6 Neighbour Discovery, or to forward all ARP/IPV6 Neighbour Solicitation traffic to the SMF 115, for Ethernet PDU Sessions.
Configures traffic steering at UPF 155 to route traffic to proper destination.

In some embodiments, the NEF 145 may support (but not limited thereto) at least one of:

### Exposure of Capabilities and Events:

NF capabilities and events may be securely exposed by NEF 145 for e.g. 3rd party, Application Functions 125, Edge Computing as described in clause 5.13 of TS 23.501.

NEF 145 stores/retrieves information as structured data using a standardized interface (Nudr) to the Unified Data Repository (UDR).

Secure Provision of Information from External Application to 3GPP Network:

It provides a means for the Application Functions 125 to securely provide information to 3GPP network, e.g. Expected UE Behaviour, 5G-VN group information, time synchronization service information and service specific information. In that case the NEF 145 may authenticate and authorize and assist in throttling the Application Functions 125.

### Translation of Internal-External Information:

It translates between information exchanged with the AF 125 and information exchanged with the internal network function. For example, it translates between an AF-Service-Identifier and internal 5G Core information such as Data Network Name (DNN), Single-Network Slice Selection Assistance Information (S-NSSAI), as described in clause 5.6.7 of TS 23.501.

In particular, NEF 145 handles masking of network and user sensitive information to external AF 125's according to the network policy.

The NEF 145 receives information from other network functions (based on exposed capabilities of other network functions). NEF 145 stores the received information as structured data using a standardized interface to a UDR. The stored information can be accessed and “re-exposed” by the NEF 145 to other network functions and Application Functions 125, and used for other purposes such as analytics.

In some embodiments, the AF 125 may interact with the 3GPP Core Network in order to provide services, for example to support the following:
Application influence on traffic routing (see clause 5.6.7 of TS 23.501);
Accessing NEF 145 (see clause 5.20 of TS 23. 501);
Interacting with the Policy framework for policy control (see clause 5.14 of TS 23. 501).

Based on operator deployment, AFs 125 considered to be trusted by the operator can be allowed to interact directly with relevant Network Functions. AFs 125 not allowed by the operator to access directly the Network Functions shall use the external exposure framework (see clause 7.3 of TS 23.501) via the NEF 145 to interact with relevant Network Functions.

In some embodiments, the PCF 120 may support (but not limited thereto) at least one of:
Supporting unified policy framework to govern network behaviour.
Providing policy rules to Control Plane (CP) function(s) to enforce them.
Accessing subscription information relevant for policy decisions in a UDR.

In some embodiments, the NRF 150 may support (but not limited thereto) at least one of:
Supporting service discovery function. Receive NF Discovery Request from NF instance or Service Communication Proxy (SCP), and provides the information of the discovered NF instances (be discovered) to the NF instance or SCP.
Maintaining the NF profile of available NF instances and their supported services.
Notifying about newly registered/updated/deregistered NF and SCP instances along with its potential NF services to the subscribed NF service consumer or SCP.
Maintaining the health status of NFs and SCP.

In some embodiments, the BSF 135 may support (but not limited thereto):
allowing a PCF 120 to register/deregister itself and to be discoverable by NF service consumers.

There may be both PCF 120 for a PDU Session and PCF 120 for a UE. Each of them may separately and independently register itself at the BSF 135. Each of them may separately and independently be discovered by a consumer of the BSF 135.

With an explicit subscription, features may be negotiated between an NF service consumer (NFsc) and an NF service producer (NFsp) during the creation of the subscription resource. In this way, when the NFsc sends a notification to the NFsp, the information related to the notified event may be according to the negotiated features.

During implicit subscription of type 1 mentioned earlier, features may be negotiated as part of the service procedures, and the notifications sent by the NFsc may be according to the negotiated features as well.

For implicit subscriptions of type 2 mentioned earlier, feature negotiation/awareness may be covered when the NFsc may select a NFsp of a certain type to send a notification: “An NF instance should register all the features it supports as NF Service Consumer in the corresponding default notification subscription in its NF profile to the NRF, to enable NF Service Producer to select NF Service Consumer supporting specific features”.

For the “other kind of subscriptions” (called non-direct subscriptions in the rest of the present disclosure) where the NFsc needs to interact with an NFsp that provided its Notification URI via a different service and using a different path, feature negotiation is not specified.

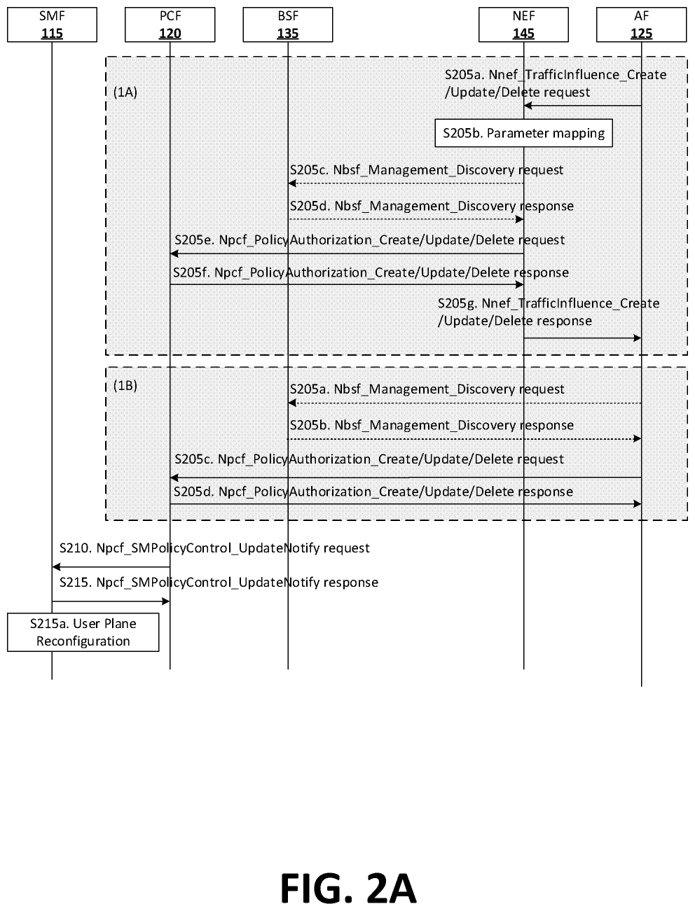

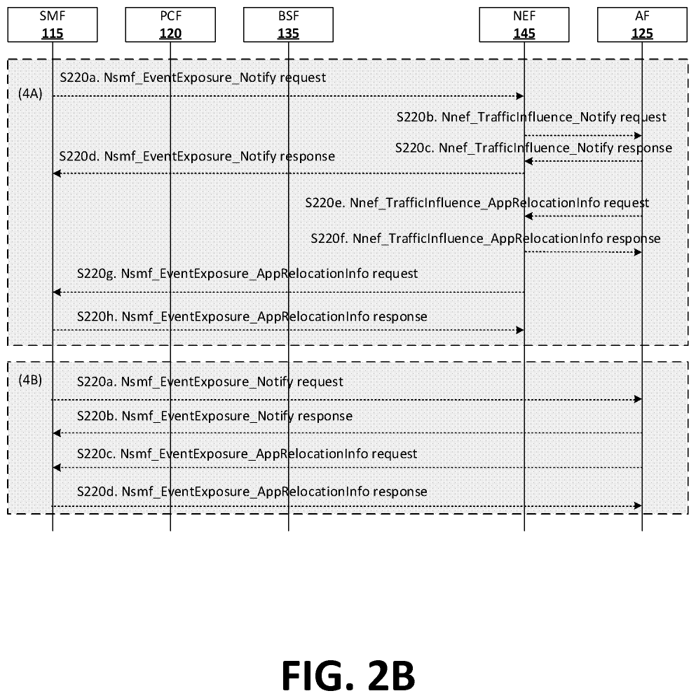

As described above, there are cases within the PCC framework where the AF/NEF subscribes in the PCF or SMF to be notified about certain events in the 5G Core Network. An example of such cases is shown in FIG. 2A and FIG. 2B. FIG. 2A and FIG. 2B are diagrams illustrating an exemplary procedure in which feature discovery in non-direct subscription scenarios according to an embodiment of the present disclosure may be applicable.

As described in 3GPP TS 23.501 subclause 5.6.7, an AF 125 may send requests to influence SMF routing decisions for User Plane traffic of PDU Sessions. The AF 125 may also provide in its request subscriptions to SMF events (e.g. UP path change).

In some embodiments, AF 125 requests targeting an individual UE address: such requests may be routed (by the AF 125 or by the NEF 145) to an individual PCF 120 using the BSF 135 or by configuration as described in subclause 5.5.3.2 of TS 29.513. Such requests target an on-going PDU Session. Whether the AF 125 needs to use the NEF 145 or not depends on local deployment.

As shown in FIG. 2A, in 1A, the AF 125 may send the AF request to PCF 120 via the NEF 145.

At steps S205a, to create a new AF request, the AF 125 may invoke the Nnef_TrafficInfluence_Create service operation to the NEF 145 by sending the HTTP POST request to the “Traffic Influence Subscription” resource. Further, to update an existing AF request, the AF 125 may invoke the Nnef_TrafficInfluence_Update service operation by sending the HTTP PUT or PATCH request to the “Individual Traffic Influence Subscription” resource. Furthermore, to remove an existing AF request, the AF 125 may invoke the Nnef_TrafficInfluence_Delete service operation by sending the HTTP DELETE request to the “Individual Traffic Influence Subscription” resource.

At step S205b, upon receipt of the AF request, the NEF 145 may authorize it and then perform the mapping from the information provided by the AF 125 into information needed by the 5GC as described in 3GPP TS 23.501 and 3GPP TS 23.502.

At steps S205c and S205d, if the PCF address is not available on the NEF 145 based on local configuration, the NEF 145 may invoke the Nbsf_Management_Discovery service operation, specified in subclause 8.5.4 of TS 29.513, to obtain the selected PCF ID for the ongoing PDU session identified by the individual UE address in the AF request.

At steps S205e and S205f, the NEF 145 may forward the AF request to the PCF 120. When receiving the Nnef_TrafficInfluence_Create request in step S205a, the NEF 145 may invoke the Npcf_PolicyAuthorization_Create service operation by sending the HTTP POST request to the “Application Sessions” resource as described in subclause 5.2.2.2.2.1 of TS 29.513. When receiving the Nnef_TrafficInfluence_Update request in step S205a, the NEF 145 may invoke the Npcf_PolicyAuthorization_Update service operation by sending the HTTP PATCH request to the “Individual Application Session Context” resource as described in subclause 5.2.2.2.2.2 of TS 29.513. When receiving the Nnef_TrafficInfluence_Delete request in step S205a, the NEF 145 may invoke the Npcf_PolicyAuthorization_Delete service operation by sending the HTTP POST request to the “Individual Application Session Context” resource as described in subclause 5.2.2.2.2.3 of TS 29.513.

At step S205g, the NEF 145 may send the HTTP response message to the AF 125 correspondingly.

As also shown in FIG. 2A, in 1B, the AF 125 may send the AF request to PCF 120 directly.

At steps S205a and S205b, if the PCF address is not available on the AF 125 based on local configuration, the AF 125 may invoke the Nbsf_Management_Discovery service operation, as specified in subclause 8.5.4 of TS 29.513, to obtain the selected PCF ID for the ongoing PDU session identified by the individual UE address in its request.

At steps S205c and S205d, to create a new AF request, the AF 125 may invoke the Npcf_PolicyAuthorization_Create service operation by sending the HTTP POST request to the “Application Sessions” resource as described in subclause 5.2.2.2.2.1 of TS 29.513. Further, to update an existing AF request, the AF 125 may invoke the Npcf_PolicyAuthorization_Update service operation by sending the HTTP PATCH request to the “Individual Application Session Context” resource as described in subclause 5.2.2.2.2.2 of TS 29.513. Furthermore, to remove an existing AF request, the AF 125 may invoke the Npcf_PolicyAuthorization_Delete service operation by sending the HTTP POST request to the “Individual Application Session Context” resource as described in subclause 5.2.2.2.2.3 of TS 29.513.

At steps S210 and S215, upon receipt of the AF request, the PCF 120 may invoke the Npcf_SMPolicyControl_UpdateNotify service operation to update the SMF 115 with corresponding PCC rule(s) by sending the HTTP POST request to the callback URI “{notificationUri}/update” as described in subclause 5.2.2.2.1 of TS 29.513. If the AF 125 subscribes to UP Path change event, the PCF 120 may include the related subscription information within the corresponding PCC rule(s).
For the case of 4A shown in FIG. 2B, the PCF 120 may include in the PCC rule(s) the Notification URI pointing to the NEF 145 and the Notification Correlation ID assigned by NEF 145.
For the case of 4B shown in FIG. 2B, the PCF 120 may include in the PCC rule(s) the Notification URI pointing to the AF 125 and the Notification Correlation ID assigned by AF 125.

If the AF 125 unsubscribes from UP Path change event, the PCF 120 may remove the related subscription information from the corresponding PCC rule(s) as specified in 3GPP TS 29.512.

At step S215a, when the SMF 115 installs PCC rule successfully, the SMF 115 may determine whether UP path change needs to be enforced.

Referring to FIG. 2B, in 4A, in case of 1A, if the SMF 115 observes PDU Session related event(s) that AF 125 has subscribed to, the SMF 115 may send a notification to the AF 125 via the NEF 145.

At step S220a, if the SMF 115 observes PDU Session related event(s) that AF 125 has subscribed to, the SMF 115 may invoke the Nsmf_EventExposure_Notify service operation to the NEF 145 by sending an HTTP POST request to the callback URI “{notifUri}”. If the indication of AF acknowledgement to be expected was included in the PCC rule(s), the SMF 115 may notify with an URI for the AF acknowledgement as described in 3GPP TS 29.508.

At step S220b, when receiving the Nsmf_EventExposure_Notify service operation, the NEF 145 may perform information mapping (e.g. Notification Correlation ID to AF Transaction ID), and invoke the Nnef_TrafficInfluence_Notify service operation to forward the notification to the AF 125 by sending the HTTP request to the callback URI “notificationDestination” as specified in 3GPP TS 29.522. If the notification from the SMF 115 includes an URI for the AF acknowledgement, the NEF 145 may also notify with a URI for the AF acknowledgement as described in 3GPP TS 29.522.

At step S220c, the AF 125 may send an HTTP “204 No Content” response to the NEF 145.

At step S220d, the NEF 145 may send an HTTP “204 No Content” response to the SMF 115.

At steps S220e and S220f, when receiving the notification with the URI for AF acknowledgement from the NEF 145, the AF 125 may invoke Nnef_TrafficInfluence_AppRelocationInfo service operation by sending an HTTP POST request to the callback URI “{afAckUri}” to acknowledge the notification, and the NEF 145 may send a “204 No Content” response to the AF 125.

At steps S220g and S220h, when receiving the AF acknowledgement from the AF 125, to forward it to the SMF 115, the NEF 145 may invoke Nsmf_EventExposure_AppRelocationInfo service operation by sending an HTTP POST request to the callback URI “{ackUri}”, and the SMF 115 may send a “204 No Content” response to the NEF 145. If the NEF 145 receives the indication that buffering of uplink traffic to the target Data Network Access Identifier (DNAI) is needed and the NEF 145 determines that the SMF 115 supports the “ULBuffering” feature via the Nnrf_NFDiscovery service operation as defined in 3GPP TS 29.510, the NEF 145 may provide the indication that buffering of uplink traffic to the target DNAI is needed to the SMF 115.

Referring to FIG. 2B, in 4B, in case of 1B, if the SMF 115 observes PDU Session related event(s) that AF 125 has subscribed to, the SMF 115 may send a notification to the AF 125 directly.

At steps S220a and S220b, the SMF 115 may invoke Nsmf_EventExposure_Notify service operation to the AF 125 directly by sending an HTTP POST request to the callback URI “{notifUri}”, and the AF 125 may send a “204 No Content” response to the SMF 115. If the indication of AF acknowledgement to be expected was included in the PCC rule(s), the SMF 115 may provide an URI for the AF acknowledgement as described in 3GPP TS 29.508.

At steps S220c and S220d, when receiving the notification with the URI for AF acknowledgement from the SMF 115, the AF 125 may invoke Nsmf_EventExposure_AppRelocationInfo service operation by sending an HTTP POST request to the callback URI “{ackUri}” to acknowledge the notification, and the SMF 115 may send a “204 No Content” response to the AF 125.

For simplicity reasons, option B (i.e., 1B/4B) in FIG. 2A and FIG. 2B is used to describe the problem in feature discovery in non-direct subscription scenarios. The same problem will also occur with Option A (i.e., 1A/4A). In this case (i.e. Option A) the NEF 145 would face the problem described for the AF 125 in option B.

With Option B in mind, the non-direct subscription occurs via steps S205c in 1B and S210. The SMF 115 will receive the indication that it needs to directly notify AF 125 about the non-directly subscribed event and the notification address where the notification has to be sent. This notification will occur in step S220a in 4B in FIG. 2B.

When the NF Service Producer (SMF 115 in the example above) needs to notify the NF Service Consumer (AF 125 in this example) about the event that was non-directly subscribed, the NF Service Producer does not know whether the receiver of the notification supports the required features for the success of the functionality. That is, the SMF 115 is unaware of whether there is additional logic and information generated by the SMF 115 that, based on feature support, should be provided to the NEF 145/AF 125.

Similarly, when the AF 125 non-directly subscribes to receive certain information (steps S205c (in 1B) and S210 in the example above), the AF 125 does not know if the final receiver of the subscription supports the required features for the success of the procedure (e.g., sending additional instructions in a subsequent Nsmf_EventExposure_AppRelocationInfo request in step S220c in 4B). It can generate error situations or wrong assumptions if the functionality is not supported by any of the involved parties.

As described above, a Network Function can discover the features that another entity supports either directly negotiating the features in the interface or consulting NRF and selecting the NF instance with the appropriate feature level support.

However, the NF Service Producer that needs to initiate the notification to an already selected NF (service) instance is unaware of the NF instance feature support that non-directly subscribed without a subscription operation. Thus, it is not possible to get the features associated to the receiver of the notification.

To solve or at least alleviate the above problems, some embodiments are provided in the present disclosure, which may cover different alternatives.

Alternative A: Solution based on the storage/discovery in the NRF of the Notification URI

The main concept of this option is briefly described as follows:
1) The NF instance that subscribes to receive notifications without using an explicit subscription operation (either using an indirect path or using a previously received notification request) will register the Notification URI, which will be provided to the final entity that will initiate the notification, as part of the default notification subscription within the NF Profile, in addition to the features it supports as NF consumer.
2) The NF instance, which needs to initiate a notification based on a non-direct subscription to an already selected NF instance identified by the received Notification URI, will discover the NF instance that support the required supported features and that have included a callback URI as part of the default notification subscription information, for the indicated service, that fully match the provided Notification URI in their NF profile.

If there is a discovered NF instance that matches the request, the NF instance will start the notification according to the supported functionality. If there is no NF instance that matches the request, the NF service consumer will consider that the features are not supported and will behave accordingly.

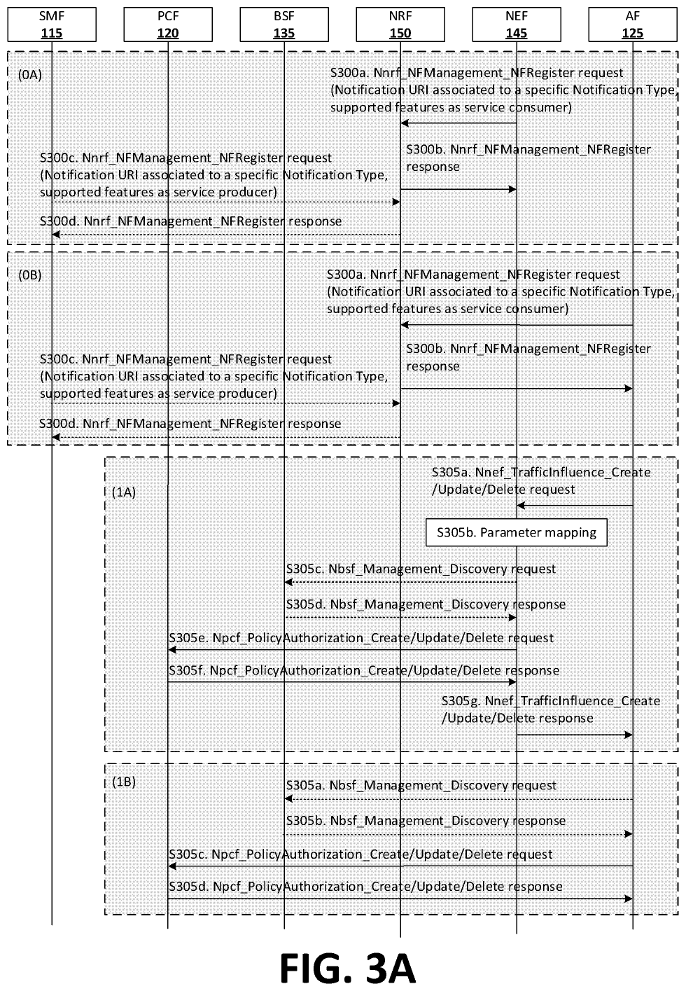

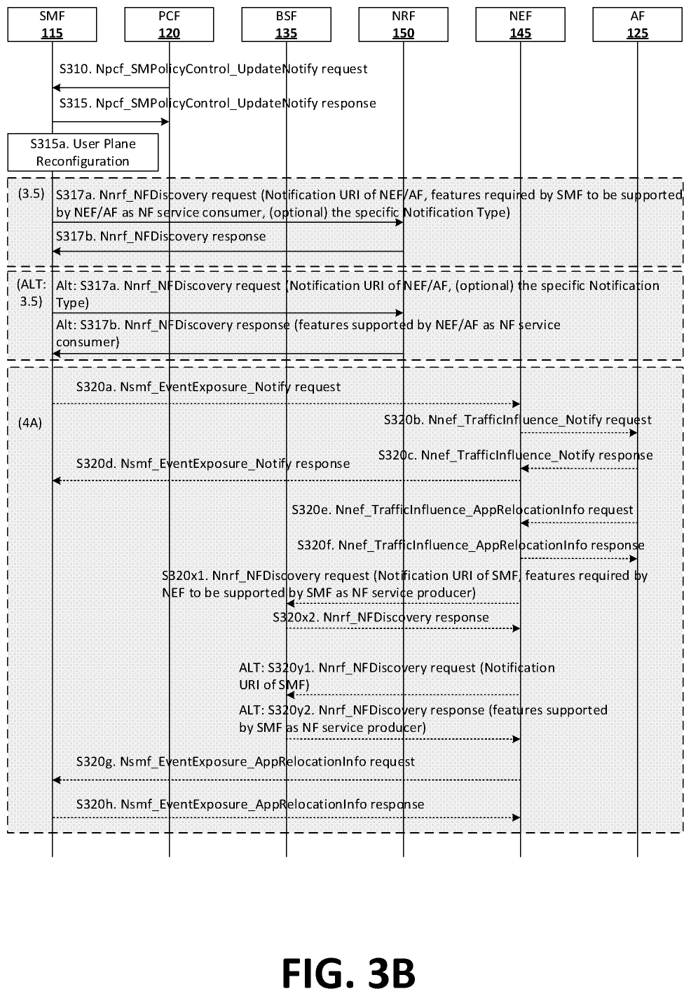

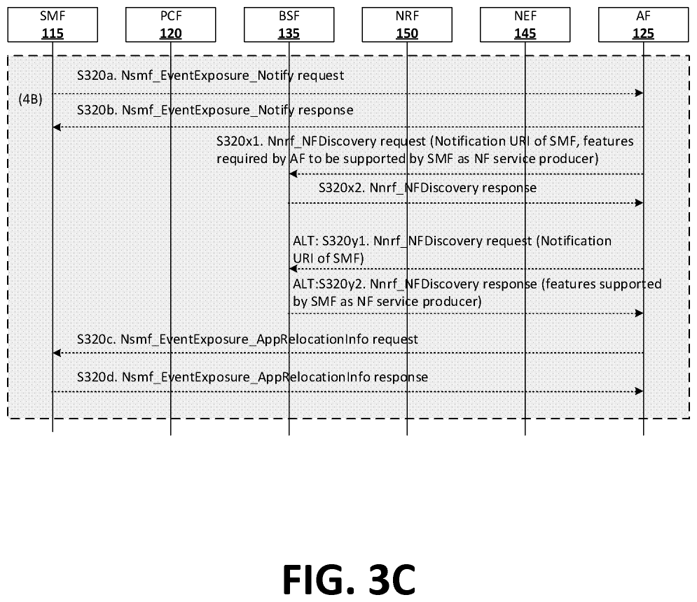

This alternative A will be described in detail with reference to FIG. 3A through FIG. 3C.

### Alternative B: Solution Based on the Transmission of the NF Instance Id Via the Indirect Path

The main concept of this option is described below:
The NF instance that subscribes to receive notifications without using an explicit subscription operation (either using an indirect path or using a previously received notification request) will register, as part of its NF profile, its NF Instance Id and, as part of the default notification subscription within the NF Profile, the features it supports as NF consumer.
The NF instance that subscribes to be notified of events via an indirect path provides its NF instance identifier to the final NF instance that will initiate the notification using that indirect path.
The NF instance that needs to initiate a notification based on a non-direct subscription, will use the received NF Instance Id in order to query the NRF for the NF profile related to that NF instance and will find out the features supported by that NF instance, within the default notification subscription.

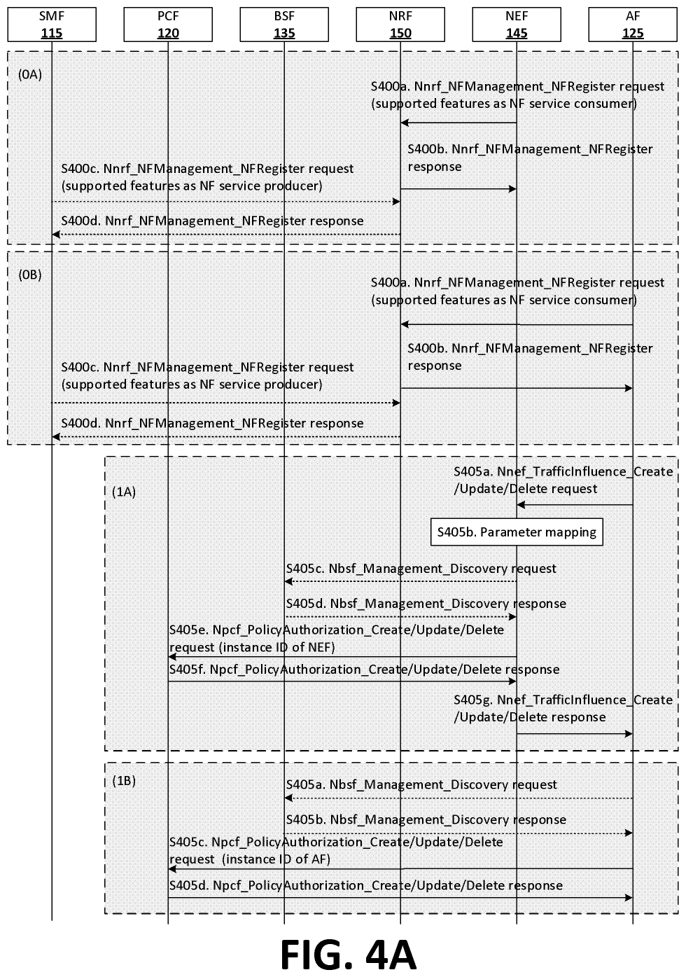

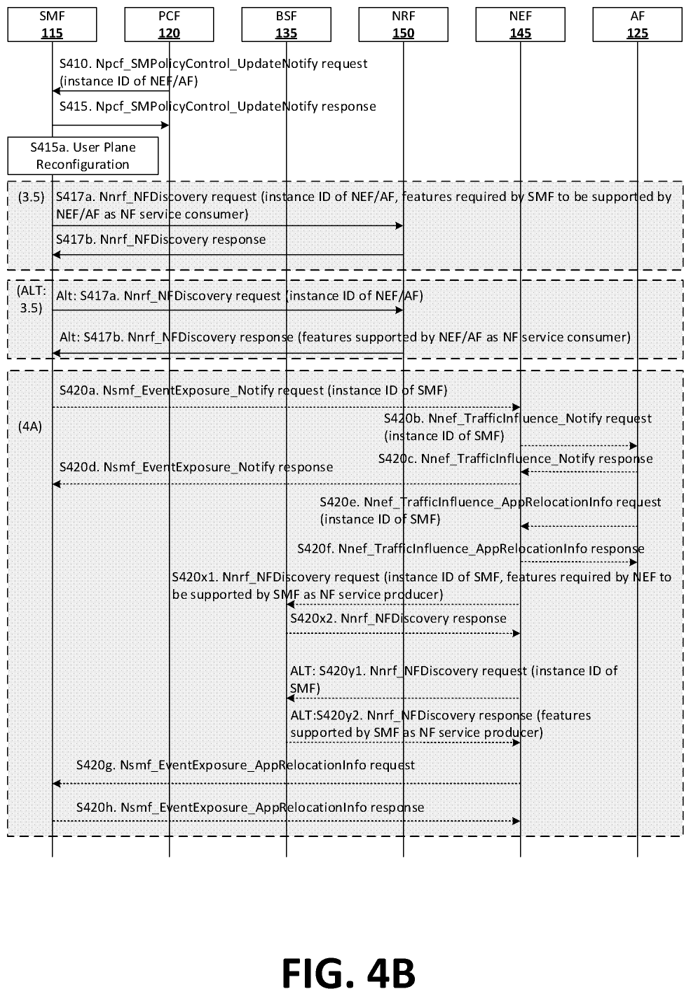

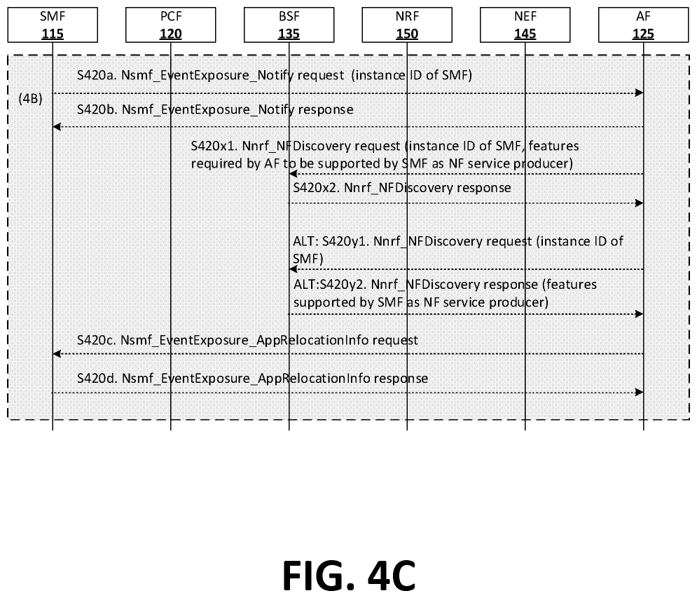

This alternative B will be described in detail with reference to FIG. 4A through FIG. 4C.

### Alternative C: Solution Based on the Transmission of the Features Supported by the NF Instance Receiver of the Notifications Via the Indirect Path.

The main concept of this option is described below:
The NF instance that subscribes to be notified of events via an indirect path provides the features supported as NF service consumer in the related API to the final NF service producer using that indirect path.
The NF instance (NF service producer) that needs to initiate a notification based on a non-direct subscription will identify the features supported by that NF instance (NF service consumer) as received in the direct path.

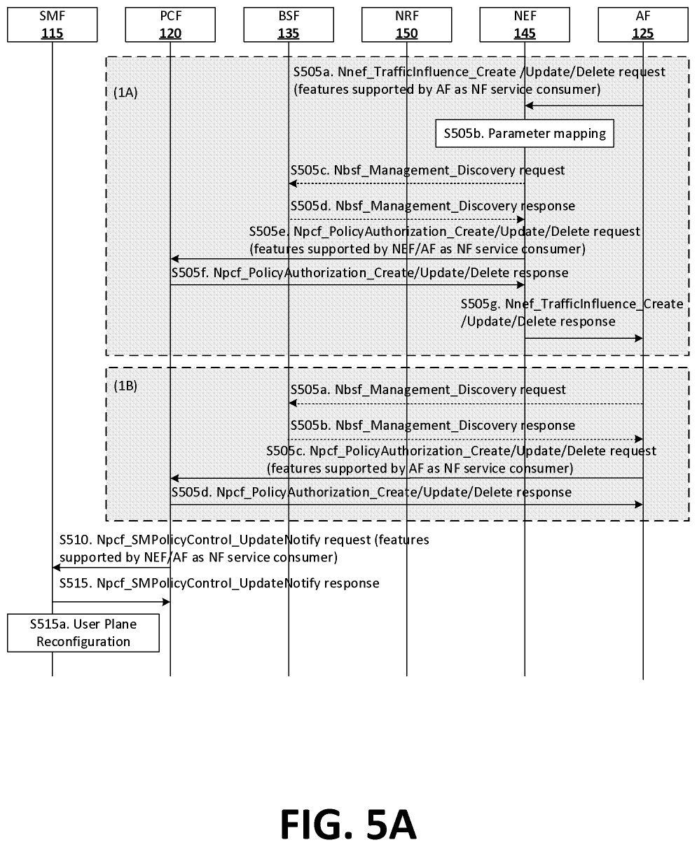

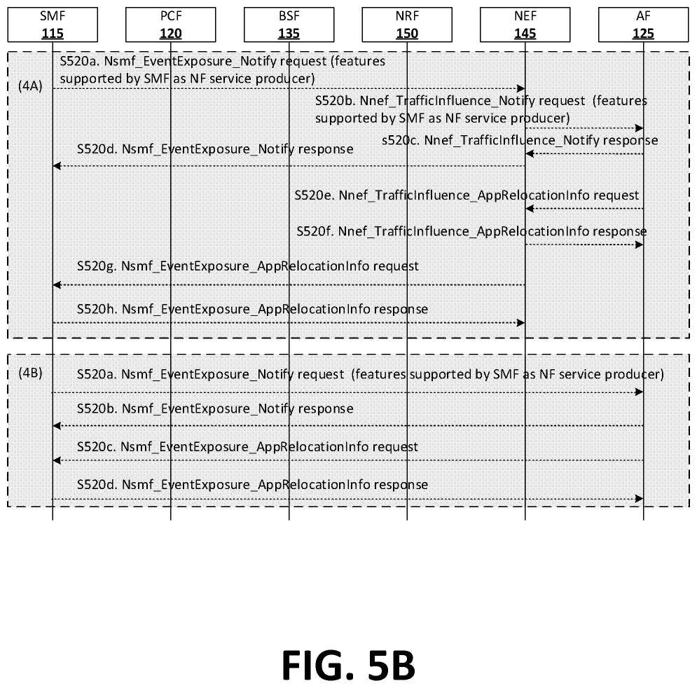

This alternative C will be described in detail with reference to FIG. 5A through FIG. 5B.

Further, a text proposal to cover the above alternatives is provided as Appendix A below.

With some embodiments of the present disclosure, it enables Network Functions that require to initiate a notification to an already selected NF (service) instance, based on a non-direct subscription that occurred via a different path than the one used to report notification, using different services than those used in the notification or based on a previous notification to be aware of the features that the receiver of the notification supports.

FIG. 3A through FIG. 3C are diagrams illustrating an exemplary procedure for feature discovery in non-direct subscription scenarios according to an embodiment of the present disclosure.

Referring to FIG. 3A, in 0A/0B, at least one of the NEF 145, the AF 125, and the SMF 115 may register itself in the NRF 150, for example, by invoking the Nnrf_NFManagement_NFRegister service operation.

For example, at step S300a and S300b in 0A, the NEF 145 may send an Nnrf_NFManagement_NFRegister request to the NRF 150 to register itself in the NRF 150, and upon successful registration, an Nnrf_NFManagement_NFRegister response may be sent back from the NRF 150 to the NEF 145. In some embodiments, the request may comprise at least one of a Notification URI (pointing or otherwise associated to NEF 145) associated to a specific Notification Type and one or more features supported by the NEF 145 as a service consumer. In some embodiments, the one or more features may be registered in the NRF 150 as “supportedFeatures” in one of “defaultNotificationSubscriptions” of one of “nfServices” of the “NFProfile” for the NEF 145, wherein the “notificationType” of the one of “defaultNotificationSubscriptions” may be “AF_INFLUENCE_EVENT_NOTIFICATION” or “EE_NON_DIRECT_SUBSC” as will be described below, and wherein the “callbackUri” of the one of “defaultNotificationSubscriptions” may be the Notification URI for NEF 145. In some embodiment, the one of “nfServices” may be any service that is subsequently involved, for example, “Nsmf_EventExposure” as shown in FIG. 3A through FIG. 3C. However, the present disclosure is not limited thereto.

Similarly, at step S300a and S300b in 0B, the AF 125 may send an Nnrf_NFManagement_NFRegister request to the NRF 150 to register itself in the NRF 150, and upon successful registration, an Nnrf_NFManagement_NFRegister response may be sent back from the NRF 150 to the AF 125. In some embodiments, the request may comprise at least one of a Notification URI (pointing or otherwise associated to AF 125) associated to a specific Notification Type and one or more features supported by the AF 125 as a service consumer. In some embodiments, the one or more features may be registered in the NRF 150 as “supportedFeatures” in one of “defaultNotificationSubscriptions” of one of “nfServices” of the “NFProfile” for the AF 125, wherein the “notificationType” of the one of “defaultNotificationSubscriptions” may be “AF_INFLUENCE_EVENT_NOTIFICATION” or “EE_NON_DIRECT_SUBSC” as will be described below, and wherein the “callbackUri” of the one of “defaultNotificationSubscriptions” may be the Notification URI for AF 125. In some embodiment, the one of “nfServices” may be any service that is subsequently involved, for example, “Nsmf_EventExposure” as shown in FIG. 3A through FIG. 3C. However, the present disclosure is not limited thereto.

Similarly, at step S300c and S300d in 0A and/or 0B, the SMF 115 may also send an Nnrf_NFManagement_NFRegister request to the NRF 150 to register itself in the NRF 150, and upon successful registration, an Nnrf_NFManagement_NFRegister response may be sent back from the NRF 150 to the SMF 115. In some embodiments, the request may comprise at least one of a Notification URI (pointing or otherwise associated to SMF 115) associated to a specific Notification Type and one or more features supported by the SMF 115 as a service producer. In some embodiments, the one or more features may be registered in the NRF 150 as “supportedFeatures” in one of “nfServices” of the “NFProfile” for the SMF 115, wherein the “notificationType” of one of “defaultNotificationSubscriptions” of the one of “nfServices” of the “NFProfile” may be “AF_INFLUENCE_EVENT_NOTIFICATION” or “EE_NON_DIRECT_SUBSC” as will be described below, and wherein the “callbackUri” of the one of “defaultNotificationSubscriptions” may be the Notification URI for SMF 115. In some embodiment, the one of “nfServices” may be any service that is subsequently involved, for example, “Nsmf_EventExposure” as shown in FIG. 3A through FIG. 3C. However, the present disclosure is not limited thereto.

As defined in the subclause 6.1.6.2.4 of TS 29.510, the default Notification Subscription in the NF profile includes the Notification URI where the Network Function instances will receive the notifications, together with the features it supports as NF consumer, and the related service. In some embodiments, the default Notification Subscription in the NF profile may include a new Notification Type (two alternative names are provided, one specific, one generic) as mentioned earlier:

| | |
|---|---|
| AF_INFLUENCE_ | SMF notification of PDU session events |
| EVENT_NOTIFICATION | related to AF influence on traffic routing. |
| | This notification type shall be registered by |
| | the NF Instance in a default notification |
| | subscription at NFProfile level. |
| EE_NON_ | NF notification of events related to a |
| DIRECT_SUBSC | subscription following a non-direct path. |
| | This notification type shall be registered by |
| | the NF Instance in a default notification |
| | subscription at NFProfile level. |

For example, the requests sent from the NEF 145, the AF 125, and/or the SMF 115 may comprise a Notification URI associated to this new Notification Type (e.g., AF_INFLUENCE_EVENT_NOTIFICATION or EE_NON_DIRECT_SUBSC).

However, the present disclosure is not limited thereto. In some other embodiments, another Notification Type name may be used. Further, in some other embodiments, the new Notification Type may be registered by the NF Instance in a default notification subscription at a different level than NFProfile. For example, the new Notification Type may be registered by the NF Instance in a default notification subscription at NFService level, as also mentioned above.

Steps in 1A/1B and steps S310, S315, and S315a are substantially similar to steps in 1A/1B and steps S210, S215, and S215a shown in FIG. 2A, and therefore a detailed description thereof may be omitted for simplicity.

Referring to FIG. 3B, in the block 3.5, before executing step S320a in 4A/4B, the SMF 115 may contact the NRF 150, at step S317a, using the Nnrf_NFDiscovery service to discover the NEF (option A)/AF (option B) instances that support the required features for this service (e.g., SMF Event Exposure) and that include a Notification URI in their profile fully match with the provided Notification URI. The NRF 150 may provide, at step S317b, the NEF/AF instances that match the request. After that, the SMF 115 may continue the procedure according to the supported features. If no NF instance is provided, the SMF 115 may continue the procedure assuming the features are not supported.

Alternatively, in the block ALT: 3.5, the SMF 115 may contact the NRF 150, at step S317a, using the Nnrf_NFDiscovery service to discover the NEF/AF instances that contain, for the indicated service, a Notification URI in their profile that fully match with the provided Notification URI. The SMF 115, based on the features supported for the retrieved NEF/AF instance, may continue the procedure with the NEF 145/AF 125.

Further, in the block 3.5 and/or ALT: 3.5, the SMF 115 may further indicate the same specific Notification Type as that used in 0A/0B, such that the NRF 150 may narrow down its searching scope with this parameter and provide the response faster.

Some of the steps in 4A/4B (e.g., steps S320a, S320b, S320c, S320d, S320e, S320f, S320g, and S320h in 4A and steps S320a, S320b, S320c, and S320d in 4B) are similar to those (e.g., steps S220a, S220b, S220c, S220d, S220e, S220f, S220g, and S220h in 4A and steps S220a, S220b, S220c, and S220d in 4B) shown in FIG. 2B, and therefore a detailed description thereof may be omitted for simplicity.

However, if steps S320e and S320g in 4A and/or S320c in 4B need to be initiated according to current procedures, the NEF 145 and/or the AF 125 may contact the NRF 150 using the Nnrf_NFDiscovery service to discover the SMF instances that support the required features for this service (SMF Event Exposure) and that include a Notification URI in their profile that fully match the Notification URI as received in step S320a (both 4A and 4B).

For example, before executing step S320g in 4A, the NEF 145 may contact the NRF 150, at step S320x1, using the Nnrf_NFDiscovery service to discover the SMF instances that support the required features for this service (SMF Event Exposure) and that include a Notification URI in their profile fully match with the provided Notification URI. The NRF 150 may provide, at step S320x2, the SMF instances that match the request. After that, the NEF 145 may continue the procedure according to the supported features. If no NF instance is provided, the NEF 145 may continue the procedure assuming the features are not supported.

Alternatively, the NEF 145 may contact the NRF 150, at step S320y1, using the Nnrf_NFDiscovery service to discover the SMF instances that contain, for the indicated service, a Notification URI in their profile that fully match with the provided Notification URI. The NEF 145, based on the features supported for the retrieved SMF instance, may continue the procedure with the SMF 115.

Further, in steps S320x1 and/or S320y1, the NEF 145 may further indicate the same specific Notification Type as that used in 0A/0B, such that the NRF 150 may narrow down its searching scope with this parameter and provide the response faster.

Similarly, before executing step S320c in 4B, the AF 125 may contact the NRF 150, at step S320x1, using the Nnrf_NFDiscovery service to discover the SMF instances that support the required features for this service (SMF Event Exposure) and that include a Notification URI in their profile fully match with the provided Notification URI. The NRF 150 may provide, at step S320x2, the SMF instances that match the request. After that, the AF 125 may continue the procedure according to the supported features. If no NF instance is provided, the AF 125 may continue the procedure assuming the features are not supported.

Alternatively, the AF 125 may contact the NRF 150, at step S320y1, using the Nnrf_NFDiscovery service to discover the SMF instances that contain, for the indicated service, a Notification URI in their profile that fully match with the provided Notification URI. The AF 125, based on the features supported for the retrieved SMF instance, may continue the procedure with the SMF 115.

Further, in steps S320x1 and/or S320y1, the AF 125 may further indicate the same specific Notification Type as that used in 0A/0B, such that the NRF 150 may narrow down its searching scope with this parameter and provide the response faster.

With the embodiments shown in FIG. 3A through FIG. 3C, at least one of the SMF 115, the NEF 145, and the AF 125 may discover features supported by other parties as service consumer/producer, and based thereon, they can determine whether one or more features shall be used in the communication with each other. In this way, features to be used in non-direct subscribed notification can be negotiated or otherwise determined between the involved parties.

FIG. 4A through FIG. 4C are diagrams illustrating another exemplary procedure for feature discovery in non-direct subscription scenarios according to another embodiment of the present disclosure. The embodiment shown in FIG. 4A through FIG. 4C is similar to that shown in FIG. 3A through FIG. 3C to some extent.

For example, at least one of the NEF 145, the AF 125, and the SMF 115 may register its NF profile, at steps S400a through S400d in 0A and/or 0B, in the NRF 150 using the Nnrf_NFManagement_NFRegister service operation in a similar manner as those shown in FIG. 3A. The default Notification Subscription in the NF profile may include the Notification URI where the Network Function instances will receive the notifications, together with the features it supports as NF producer and/or NF consumer, and the related service. The default Notification Subscription in the NF profile may include a new Notification Type:

| | |
|---|---|
| AF_INFLUENCE_ | SMF notification of PDU session events |
| EVENT_NOTIFICATION | related to AF influence on traffic routing. |
| | This notification type shall be registered by |
| | the NF Instance in a default notification |
| | subscription at NFProfile level. |
| EE_NON_ | NF notification of events related to a |
| DIRECT_SUBSC | subscription following a non-direct path. |
| | This notification type shall be registered by |
| | the NF Instance in a default notification |
| | subscription at NFProfile level. |

The embodiment shown in FIG. 4A through FIG. 4C differs from the embodiment shown in FIG. 3A through FIG. 3C at least in following steps.

For example, at steps S405a and/or S405e in 1A and/or step 405c in 1B, the NF instance Identifier that identifies the NF instance that will receive the notifications may be added in the corresponding messages. In some embodiments, the NEF 145 may add its NF instance ID in the Npcf_PolicyAuthorization_Create/Update/Delete request message to the PCF 120 at step S405e in 1A. In some embodiments, the AF 125 may add its NF instance ID in the Nnef_TrafficInfluence_Create/Update/Delete request message to the NEF 145 at step S405a, and the NEF 145 may then add the received NF instance ID of the AF 125 in the Npcf_PolicyAuthorization_Create/Update/Delete request message to the PCF 120 at step S405e in 1A. In some embodiments, the AF 125 may add its NF instance ID in the Npcf_PolicyAuthorization_Create/Update/Delete request message to the PCF 120 at step S405c in 1B.

With the received NF instance ID, the PCF 120 may transmit the received NF instance ID in the Npcf_SMPolicyControl_UpdateNotify request message to the SMF 115 at step S410, such that the SMF 115 may be aware of the NF instance ID of the receiver of the non-direct subscribed notification.

Further, at the block 3.5, before executing step S420a in 4A and/or 4B, the SMF 115 may contact, at step S417a, the NRF 150 using the Nnrf_NFDiscovery service using the received NF instance id and one or more features required by the SMF 115 to be supported by NEF 145/AF 125 as NF service consumer, in order to obtain the related NF profile. The NRF 150 may provide, at step S417b, the NF profile of the NEF/AF instance that matches the request. In some embodiments, the SMF 115 may continue the procedure according to the supported features for that instance.

Alternatively, at the block ALT: 3.5, before executing step S420a in 4A and/or 4B, the SMF 115 may contact, at step S417a, the NRF 150 using the Nnrf_NFDiscovery service using the received NF instance id, in order to obtain the related NF profile. The NRF 150 may provide, at step S417b, the NF profile of the NEF/AF instance that matches the request. In some embodiments, the SMF 115 may continue the procedure according to the supported features for that instance.

Further, at steps S420a and S420b in 4A and step 420a in 4B, the NF instance Identifier may be sent to the NEF 145 and/or the AF 125. If steps S420e and S420g in 4A and/or step 420c in 4B need to be initiated according to current procedures, the NEF 145 and/or the AF 125 may obtain the NF instance Id as provided by the SMF 115 and contact the NRF 150, at step S420x1 or S420y1 using the Nnrf_NFDiscovery service to discover the SMF profile for the provided instance. The NRF 150 may provide, at step S420x2 or S420y2, the SMF profile for the instance that matches the request. The NEF 145 and/or the AF 125 may continue the procedure according to the supported features. If no NF instance is provided, the NEF 145 and/or the AF 125 may continue the procedure assuming no feature is supported.

With the embodiments shown in FIG. 4A through FIG. 4C, at least one of the SMF 115, the NEF 145, and the AF 125 may discover features supported by other parties as service consumer/producer, and based thereon, they can determine whether one or more features shall be used in the communication with each other. In this way, features to be used in non-direct subscribed notification can be negotiated or otherwise determined between the involved parties.

FIG. 5A and FIG. 5B are diagrams illustrating yet another exemplary procedure for feature discovery in non-direct subscription scenarios according to yet another embodiment of the present disclosure. Unlike the embodiments shown in FIG. 3A through FIG. 3C or the embodiments shown in FIG. 4A through FIG. 4C, in the embodiments shown in FIG. 5A and FIG. 5B, no additional signaling from/to NRF 145 is needed. When compared with the embodiment shown in FIG. 2A and FIG. 2B, it is clear that one or more features that are supported by one party will be explicitly indicated in messages sent to other parties involved in the service of interest.

For example, at steps S505a and S505e in 1A and/or step 505c in 1B, the features that the NF instance (e.g., the NEF 145 and/or the AF 125) supports are explicitly indicated on the Nsmf API. Similarly, at steps 520a and 520b in 4A and/or step 520a in 4B, supported features are explicitly indicated to the NEF 145 and/or the AF 125.

With the embodiments shown in FIG. 5A and FIG. 5B, at least one of the SMF 115, the NEF 145, and the AF 125 may discover features supported by other parties as service consumer/producer, and based thereon, they can determine whether one or more features shall be used in the communication with each other. In this way, features to be used in non-direct subscribed notification can be negotiated or otherwise determined between the involved parties.

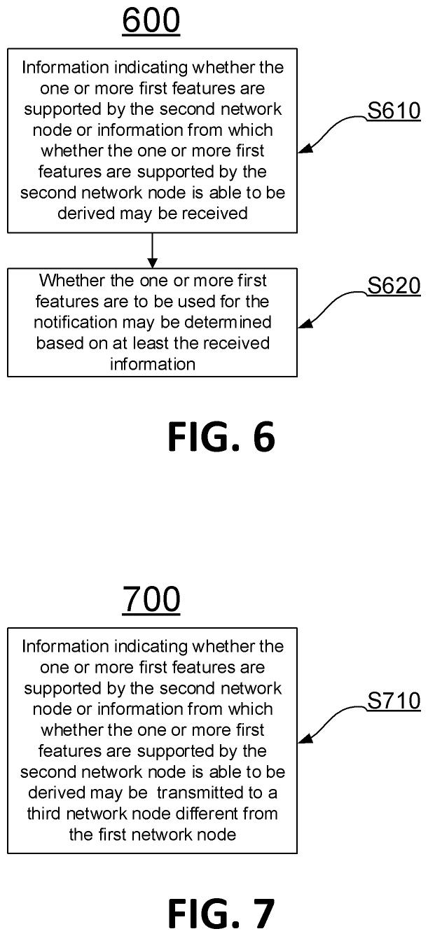

FIG. 6 is a flow chart of an exemplary method 600 at a first network node for determining whether one or more first features are to be used for notification from the first network node to a second network node or not. In some embodiments, the notification may be subscribed by a non-direct subscription operation. The method 600 may be performed by an SMF (e.g., the SMF 115). The method 600 may comprise steps S610 and S620. However, the present disclosure is not limited thereto. In some other embodiments, the method 600 may comprise more steps, less steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where information indicating whether the one or more first features are supported by the second network node or information from which whether the one or more first features are supported by the second network node is able to be derived may be received.

At step S620, whether the one or more first features are to be used for the notification may be determined based on at least the received information.

In some embodiments, the non-direct subscription operation may be a first service operation, which is associated with a first service and which is invoked by a third network node in response to a second service operation associated with a second service being invoked. In some embodiments, the first service may be different from the second service. In some embodiments, the third network node may be different from the second network node. In some embodiments, at least one of the first service and the second service may be provided by the third network node.

In some embodiments, the step of receiving the information may comprise at least one of: receiving, from the third network node, a first message indicating a notification URI, which points to the second network node; receiving, from the third network node, a first message indicating an NF instance identifier ID of the second network node; and receiving, from the third network node, a first message indicating zero or more second features supported by the second network node as an NF service consumer.

In some embodiments, when the first message indicates the notification URI pointing to the second network node, the step of determining whether the one or more first features are to be used for the notification may comprise: transmitting, to a fourth network node, a second message for discovering an NF instance that has a notification URI in its NF profile matched with the notification URI and that supports, as an NF service consumer, the one or more first features required by the first network node; and/or receiving, from the fourth network node, a third message indicating zero or one NF instance in response to the second message. In some embodiments, the step of determining whether the one or more first features are to be used for the notification may further comprise at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type. In some embodiments, when the second message further indicates the first notification type, the step of determining whether the one or more first features are to be used for the notification may further comprise at least one of: determining that the one or more first features are to be used for the notification at least in response to receiving, from the fourth network node, the third message indicating one NF instance; and determining that the one or more first features are not to be used for the notification at least in response to receiving, from the fourth network node, the third message indicating no NF instance.

In some embodiments, when the first message indicates the notification URI pointing to the second network node, the step of determining whether the one or more first features are to be used for the notification may comprise: transmitting, to a fourth network node, a second message for discovering an NF instance that has a notification URI in its NF profile matched with the notification URI; and/or receiving, from the fourth network node, a third message indicating zero or one NF instance in response to the second message, wherein when one NF instance is indicated by the third message, the third message may further indicate, for the indicated NF instance and for each of notification types indicated by the third message, zero or more second features supported by the indicated NF instance as an NF service consumer. In some embodiments, the step of determining whether the one or more first features are to be used for the notification may further comprise at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the notification URI pointing to the second network node, the step of determining whether the one or more first features are to be used for the notification may comprise: transmitting, to a fourth network node, a second message for discovering an NF instance that has a notification URI in its NF profile matched with the notification URI and associated to a first notification type, the first notification type indicating that the notification is subscribed by a non-direct subscription operation; and/or receiving, from the fourth network node, a third message indicating zero or one NF instance in response to the second message, wherein when one NF instance is indicated by the third message, the third message may further indicate, for the indicated NF instance and for the first notification type, zero or more second features supported by the indicated NF instance as an NF service consumer. In some embodiments, the step of determining whether the one or more first features are to be used for the notification may further comprise at least one of: determining that the one or more first features are to be used for the notification at least in response to receiving, from the fourth network node, the third message indicating one NF instance and in response to determining that the one or more first features are one or more of the zero or more second features; and determining that the one or more first features are not to be used for the notification at least in response to receiving, from the fourth network node, the third message indicating no NF instance or in response to, when the third message indicates one NF instance, determining that the one or more first features are not one or more of the zero or more second features.

In some embodiments, when the first message indicates the NF instance ID of the second network node, the step of determining whether the one or more first features are to be used for the notification may comprise: transmitting, to a fourth network node, a second message for discovering an NF instance that has an NF instance ID indicated in the first message and that supports, as an NF service consumer, the one or more first features required by the first network node; and/or receiving, from the fourth network node, a third message indicating zero or one NF instance in response to the second message. In some embodiments, the step of determining whether the one or more first features are to be used for the notification may further comprise at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the NF instance ID of the second network node, the step of determining whether the one or more first features are to be used for the notification may comprise: transmitting, to a fourth network node, a second message for discovering an NF instance that has an NF instance ID indicated in the first message; and/or receiving, from the fourth network node, a third message indicating zero or one NF instance in response to the second message, wherein when one NF instance is indicated by the third message, the third message may further indicate, for the indicated NF instance and for each of notification types indicated by the third message, zero or more second features supported by the indicated NF instance as an NF service consumer. In some embodiments, the step of determining whether the one or more first features are to be used for the notification may further comprise at least one of: determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

In some embodiments, when the first message indicates the zero or more second features supported by the second network node as an NF service consumer, the step of determining whether the one or more first features are to be used for the notification may comprise at least one of: determining that the one or more first features are to be used for the notification at least in response to determining that the zero or more second features supported by the second network node comprise the one or more first features; and determining that the one or more first features are not to be used for the notification at least in response to determining that the zero or more second features supported by the second network node do not comprise the one or more first features.

In some embodiments, before the step of determining whether the one or more first features are to be used for the notification, the method 600 may further comprise: transmitting, to the fourth network node, a fourth message indicating at least one of: a notification URI pointing to the first network node and associated to a first notification type, the first notification type indicating that the notification is subscribed by a non-direct subscription operation, zero or more third features supported by the first network node as an NF service producer, and an NF instance ID of the first network node.

In some embodiments, the method 600 may further comprise: transmitting, to the second network node, a fifth message as the notification, with the one or more first features used based on at least the determination of whether the one or more first features are to be used for the notification. In some embodiments, the fifth message may further indicate at least one of: a notification URI pointing to the first network node; an NF instance ID of the first network node; and zero or more third features supported by the first network node as an NF service producer.

In some embodiments, at least one of following may be true: the first network node may be an SMF; the second network node may be a NEF or AF; the third network node may be a PCF; the fourth network node may be an NRF; the first message may be an Npcf_SMPolicyControl_UpdateNotify request message; the second message may be an Nnrf_NFDiscovery_Request request message; the third message may be an Nnrf_NFDiscovery_Request response message; the fourth message may be an Nnrf_NFManagement_NFRegister request message; and the fifth message may be an Nsmf_EventExposure_Notify request message.

FIG. 7 is a flow chart of an exemplary method 700 at a second network node for facilitating a first network node in determining whether one or more first features are to be used for notification from the first network node to a second network node or not. In some embodiments, the notification may be subscribed by a non-direct subscription operation. The method 700 may be performed by a NEF or AF (e.g., the NEF 145 or the AF 125). The method 700 may comprise a step S710. However, the present disclosure is not limited thereto. In some other embodiments, the method 700 may comprise more steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where information indicating whether the one or more first features are supported by the second network node or information from which whether the one or more first features are supported by the second network node is able to be derived may be transmitted to a third network node different from the first network node.

In some embodiments, the non-direct subscription operation may be a first service operation, which may be associated with a first service and which may be invoked by the third network node in response to a second service operation associated with a second service being invoked. In some embodiments, the first service may be different from the second service. In some embodiments, the third network node may be different from the second network node. In some embodiments, at least one of the first service and the second service may be provided by the third network node. In some embodiments, the step of transmitting the information may comprise at least one of: transmitting, to the third network node, a sixth message indicating a notification URI, which points to the second network node; transmitting, to the third network node, a sixth message indicating an NF instance ID of the second network node; and transmitting, to the third network node, a sixth message indicating zero or more second features supported by the second network node as an NF service consumer.

In some embodiments, before the step of transmitting the information, the method 700 may further comprise: transmitting, to a fourth network node, a seventh message indicating at least one of: a notification URI pointing to the second network node and associated to a first notification type indicating that the notification is subscribed by a non-direct subscription operation, one or more second features supported by the second network node as an NF service consumer, and an NF instance ID of the second network node. In some embodiments, the method 700 may further comprise: receiving, from the first network node, a fifth message as the notification, with the one or more first features used based on at least the information transmitted to the third network node. In some embodiments, the fifth message may further indicate at least one of: another notification URI pointing to the first network node; an NF instance ID of the first network node; and zero or more third features supported by the first network node as an NF service producer.

In some embodiments, when the fifth message indicates the other notification URI pointing to the first network node, the method 700 may further comprise: transmitting, to a fourth network node, an eighth message for discovering an NF instance that has a notification URI in its NF profile matched with the other notification URI and that supports, as an NF service producer, one or more fourth features required by the second network node; and/or receiving, from the fourth network node, a ninth message indicating zero or one NF instance in response to the eighth message. In some embodiments, the method 700 may further comprise at least one of: determining that the one or more fourth features are to be used for another notification from the second network node to the first network node at least in response to receiving, from the fourth network node, the ninth message indicating one NF instance; and determining that the one or more fourth features are not to be used for the other notification at least in response to receiving, from the fourth network node, the ninth message indicating no NF instance.

In some embodiments, when the fifth message indicates the other notification URI pointing to the first network node, the method 700 may further comprise: transmitting, to a fourth network node, an eighth message for discovering an NF instance that has a notification URI in its NF profile matched with the other notification URI; and/or receiving, from the fourth network node, a ninth message indicating zero or one NF instance in response to the eighth message, wherein when one NF instance is indicated by the ninth message, the ninth message may further indicate, for the indicated NF instance, zero or more third features supported by the indicated NF instance as an NF service producer. In some embodiments, the method 700 may further comprise at least one of: determining that the one or more fourth features are to be used for another notification from the second network node to the first network node at least in response to receiving, from the fourth network node, the ninth message indicating one NF instance and in response to determining that the one or more fourth features are one or more of the zero or more third features; and determining that the one or more fourth features are not to be used for the other notification at least in response to receiving, from the fourth network node, the ninth message indicating no NF instance or in response to, when the ninth message indicates one NF instance, determining that the one or more fourth features are not one or more of the zero or more third features.

In some embodiments, when the fifth message indicates the NF instance ID of the first network node, the method 700 may further comprise: transmitting, to a fourth network node, an eighth message for discovering an NF instance that has an NF instance ID indicated in the fifth message and that supports, as an NF service producer, one or more fourth features required by the second network node; and/or receiving, from the fourth network node, a ninth message indicating zero or one NF instance in response to the eighth message. In some embodiments, the method 700 may further comprise at least one of: determining that the one or more fourth features are to be used for another notification from the second network node to the first network node at least in response to receiving, from the fourth network node, the ninth message indicating one NF instance; and determining that the one or more fourth features are not to be used for the other notification at least in response to receiving, from the fourth network node, the ninth message indicating no NF instance.

In some embodiments, when the fifth message indicates the NF instance ID of the first network node, the method 700 may further comprise: transmitting, to a fourth network node, an eighth message for discovering an NF instance that has an NF instance ID indicated in the fifth message; and/or receiving, from the fourth network node, a ninth message indicating zero or one NF instance in response to the eighth message, wherein when one NF instance is indicated by the ninth message, the ninth message may further indicate, for the indicated NF instance, zero or more third features supported by the indicated NF instance as an NF service producer. In some embodiments, the method 700 may further comprise at least one of: determining that the one or more fourth features are to be used for another notification from the second network node to the first network node at least in response to receiving, from the fourth network node, the ninth message indicating one NF instance and in response to determining that the one or more fourth features are one or more of the zero or more third features; and determining that the one or more fourth feature are not to be used for the other notification at least in response to receiving, from the fourth network node, the ninth message indicating no NF instance or in response to, when the ninth message indicates one NF instance, determining that the one or more fourth features are not one or more of the zero or more third features.

In some embodiments, when the fifth message indicates the zero or more third features supported by the first network node as an NF service producer, the method 700 may further comprise at least one of: determining that one or more fourth features are to be used for another notification from the second network node to the first network node at least in response to determining that the zero or more third features supported by the first network node comprise the one or more fourth features; and determining that the one or more fourth features are not to be used for the other notification at least in response to determining that the zero or more third features supported by the first network node do not comprise the one or more fourth features.

In some embodiments, the method 700 may further comprise: transmitting, to the first network node, a tenth message as the other notification, with the one or more fourth features used based on at least the determination of whether the one or more fourth features are to be used for the other notification. In some embodiments, at least one of following may be true: the first network node may be an SMF; the second network node may be a NEF or AF; the third network node may be a PCF; the fourth network node may be an NRF; the fifth message may be an Nsmf_EventExposure_Notify request message; the sixth message may be an Npcf_PolicyAuthorization_Create request message, an Npcf_PolicyAuthorization_Update request message, or an Npcf_PolicyAuthorization_Delete request message; the seventh message may be an Nnrf_NFManagement_NFRegister request message; the eighth message may be an Nnrf_NFDiscovery_Request request message; the ninth message may be an Nnrf_NFDiscovery_Request response message; and the tenth message may be an Nsmf_EventExposure_AppRelocationInfo request message.

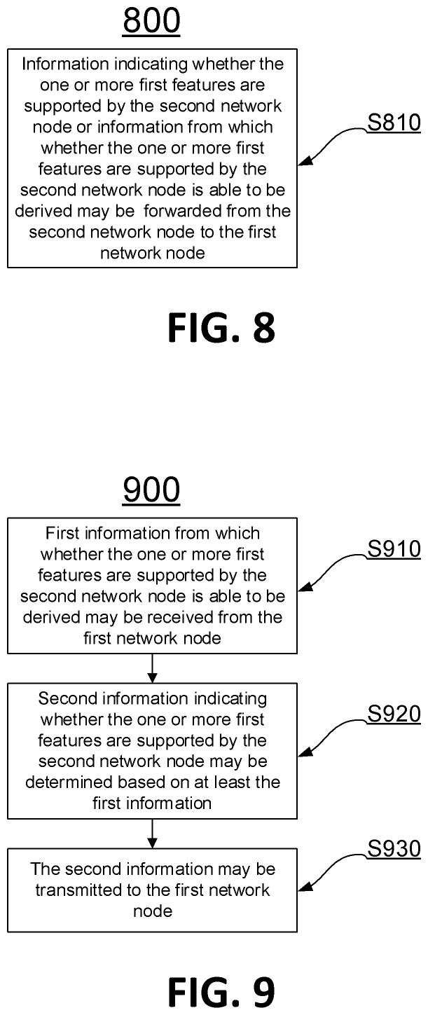

FIG. 8 is a flow chart of an exemplary method 800 at a third network node for facilitating a first network node in determining whether one or more first features are to be used for notification from the first network node to a second network node or not. In some embodiments, the notification may be subscribed by a non-direct subscription operation. The method 800 may be performed by a PCF (e.g., the PCF 120). The method 800 may comprise a step S810. However, the present disclosure is not limited thereto. In some other embodiments, the method 800 may comprise more steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where information indicating whether the one or more first features are supported by the second network node or information from which whether the one or more first features are supported by the second network node is able to be derived may be forwarded from the second network node to the first network node.

In some embodiments, the non-direct subscription operation may be a first service operation, which may be associated with a first service and which may be invoked by the third network node in response to a second service operation associated with a second service being invoked. In some embodiments, the first service may be different from the second service. In some embodiments, the third network node may be different from the second network node and/or the first network node. In some embodiments, at least one of the first service and the second service may be provided by the third network node. In some embodiments, the step of forwarding the information may comprise at least one of: receiving, from the second network node, a sixth message indicating a notification URI, which points to the second network node, and transmitting, to the first network node, a first message indicating the notification URI; receiving, from the second network node, a sixth message indicating an NF instance ID of the second network node and transmitting, to the first network node, a first message indicating the NF instance ID; and receiving, from the second network node, a sixth message indicating zero or more second features supported by the second network node as an NF service consumer and transmitting, to the first network node, a first message indicating the zero or more second features. In some embodiments, at least one of following may be true: the first network node may be an SMF; the second network node may be a NEF or AF; the third network node may be a PCF; the first message may be an Npcf_SMPolicyControl_UpdateNotify request message; and the sixth message may be an Npcf_PolicyAuthorization_Create request message, an Npcf_PolicyAuthorization_Update request message, or an Npcf_PolicyAuthorization_Delete request message.

FIG. 9 is a flow chart of an exemplary method 900 at a fourth network node for facilitating a first network node in determining whether one or more first features are to be used for notification from the first network node to a second network node or not. In some embodiments, the notification may be subscribed by a non-direct subscription operation. The method 900 may be performed by an NRF (e.g., the NRF 150). The method 900 may comprise steps S910, S920, and S930. However, the present disclosure is not limited thereto. In some other embodiments, the method 900 may comprise more steps, less steps, different steps, or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where first information from which whether the one or more first features are supported by the second network node is able to be derived may be received from the first network node.

At step S920, second information indicating whether the one or more first features are supported by the second network node may be determined based on at least the first information.

At step S930, the second information may be transmitted to the first network node.

In some embodiments, the non-direct subscription operation may be a first service operation, which may be associated with a first service and which may be invoked by a third network node in response to a second service operation associated with a second service being invoked. In some embodiments, the first service may be different from the second service. In some embodiments, the third network node may be different from the second network node and/or the first network node. In some embodiments, at least one of the first service and the second service may be provided by the third network node. In some embodiments, the first information may comprise at least one of: information indicating a notification URI pointing to the second network node; information indicating an NF instance ID of the second network node; information indicating the one or more first features; and information indicating a first notification type, which indicates that the notification is subscribed by a non-direct subscription operation.

In some embodiments, the step of receiving the first information may comprise: receiving, from the first network node, a second message for discovering an NF instance that has a notification URI in its NF profile matched with the notification URI and that supports, as an NF service consumer, the one or more first features required by the first network node, and/or wherein the step of determining the second information may comprise: determining, from one or more NF instances registered at the fourth network node, zero or one NF instance that has a notification URI in its NF profile matched with the notification URI and that supports, as an NF service consumer, the one or more first features, and/or wherein the step of transmitting the second information may comprise: transmitting, to the first network node, a third message indicating the zero or one NF instance, and/or wherein when one NF instance is determined and indicated in the third message, the third message may further indicate, for each of notification types which are registered by the indicated NF instance at the fourth network node, zero or more second features that are supported by the indicated NF instance as an NF service consumer.

In some embodiments, the step of receiving the first information may comprise: receiving, from the first network node, a second message for discovering an NF instance that has a notification URI in its NF profile matched with the notification URI and associated to the first notification type and that supports, as an NF service consumer, the one or more first features required by the first network node and associated to the first notification type, and/or wherein the step of determining the second information may comprise: determining, from one or more NF instances registered at the fourth network node, zero or one NF instance that has a notification URI in its NF profile matched with the notification URI and associated to the first notification type and that supports, as an NF service consumer, the one or more first features associated to the first notification type, and/or wherein the step of transmitting the second information may comprise: transmitting, to the first network node, a third message indicating the zero or one NF instance.

In some embodiments, the step of receiving the first information may comprise: receiving, from the first network node, a second message for discovering an NF instance that has a notification URI in its NF profile matched with the notification URI, and/or wherein the step of determining the second information may comprise: determining, from one or more NF instances registered at the fourth network node, zero or one NF instance that has a notification URI in its NF profile matched with the notification URI, and/or wherein the step of transmitting the second information may comprise: transmitting, to the first network node, a third message indicating the zero or one NF instance, and/or wherein when one NF instance is determined and indicated by the third message, the third message may further indicate, for each of notification types which are registered by the indicated NF instance at the fourth network node, zero or more second features supported by the indicated NF instance as an NF service consumer.

In some embodiments, the step of receiving the first information may comprise: receiving, from the first network node, a second message for discovering an NF instance that has a notification URI in its NF profile matched with the notification URI and associated to the first notification type, and/or wherein the step of determining the second information may comprise: determining, from one or more NF instances registered at the fourth network node, zero or one NF instance that has a notification URI in its NF profile matched with the notification URI and associated to the first notification type, and/or wherein the step of transmitting the second information may comprise: transmitting, to the first network node, a third message indicating the zero or one NF instance, and/or wherein when one NF instance is determined and indicated by the third message, the third message may further indicate, for the first notification type, zero or more second features supported by the indicated NF instance as an NF service consumer.

In some embodiments, the step of receiving the first information may comprise: receiving, from the first network node, a second message for discovering an NF instance that has an NF instance ID of the second network node and that supports, as an NF service consumer, the one or more first features required by the first network node, and/or wherein the step of determining the second information may comprise: determining, from one or more NF instances registered at the fourth network node, zero or one NF instance that has an NF instance ID indicated in the second message and that supports, as an NF service consumer, the one or more first features, and/or wherein the step of transmitting the second information may comprise: transmitting, to the first network node, a third message indicating the zero or one NF instance, and/or wherein when one NF instance is determined and indicated in the third message, the third message may further indicate, for each of notification types which are registered by the indicated NF instance at the fourth network node, zero or more second features supported by the indicated NF instance as an NF service consumer.

In some embodiments, the step of receiving the first information may comprise: receiving, from the first network node, a second message for discovering an NF instance that has an NF instance ID indicated in the first message, and/or wherein the step of determining the second information may comprise: determining, from one or more NF instances registered at the fourth network node, zero or one NF instance that has an NF instance ID indicated in the second message, and/or wherein the step of transmitting the second information may comprise: transmitting, to the first network node, a third message indicating zero or one NF instance in response to the second message, and/or wherein when one NF instance is determined and indicated by the third message, the third message may further indicate, for each of notification types which are registered by the indicated NF instance at the fourth network node, zero or more second features supported by the indicated NF instance as an NF service consumer.

In some embodiments, before the step of receiving the first information, the method 900 may further comprise at least one of: receiving, from the first network node, a fourth message indicating at least one of a notification URI pointing to the first network node and associated to the first notification type, zero or more third features supported by the first network node as an NF service producer, and an NF instance ID of the first network node; and receiving, from the second network node, a seventh message indicating at least one of a notification URI pointing to the second network node and associated to the first notification type, one or more second features supported by the second network node as an NF service consumer, and an NF instance ID of the second network node.

In some embodiments, the method 900 may further comprise: receiving, from the second network node, third information from which whether one or more fourth features are supported by the first network node is able to be derived; and/or determining fourth information indicating whether the one or more fourth features are supported by the first network node based on at least the third information; and/or transmitting, to the second network node, the fourth information. In some embodiments, the third information may comprise at least one of: information indicating another notification URI pointing to the first network node; information indicating an NF instance ID of the first network node; information indicating the one or more fourth features; and information indicating a first notification type, which indicates that the notification is subscribed by a non-direct subscription operation. In some embodiments, the step of receiving the third information may comprise: receiving, from the second network node, an eighth message for discovering an NF instance that has a notification URI in its NF profile matched with the other notification URI and that supports, as an NF service producer, the one or more fourth features required by the second network node, and/or wherein the step of determining the fourth information may comprise: determining, from one or more NF instances registered at the fourth network node, zero or one NF instance that has a notification URI in its NF profile matched with the other notification URI and that supports, as an NF service producer, the one or more fourth features, and/or wherein the step of transmitting the fourth information may comprise: transmitting, to the second network node, a ninth message indicating the zero or one NF instance.

In some embodiments, the step of receiving the third information may comprise: receiving, from the second network node, an eighth message for discovering an NF instance that has a notification URI in its NF profile matched with the other notification URI, and/or wherein the step of determining the fourth information may comprise: determining, from one or more NF instances registered at the fourth network node, zero or one NF instance that has a notification URI in its NF profile matched with the other notification URI, and/or wherein the step of transmitting the fourth information may comprise: transmitting, to the second network node, a ninth message indicating zero or one NF instance, and/or wherein when one NF instance is determined and indicated by the ninth message, the ninth message may further indicate zero or more third features supported by the indicated NF instance as an NF service producer.

In some embodiments, the step of receiving the third information may comprise: receiving, from the second network node, an eighth message for discovering an NF instance that has an NF instance ID of the first network node and that supports, as an NF service producer, the one or more fourth features required by the second network node, and/or wherein the step of determining the fourth information may comprise: determining, from one or more NF instances registered at the fourth network node, zero or one NF instance that has an NF instance ID of the first network node and that supports, as an NF service producer, the one or more fourth features, and/or wherein the step of transmitting the fourth information may comprise: transmitting, to the second network node, a ninth message indicating the zero or one NF instance.

In some embodiments, the step of receiving the third information may comprise: receiving, from the second network node, an eighth message for discovering an NF instance that has an NF instance ID of the first network node, and/or wherein the step of determining the fourth information may comprise: determining, from one or more NF instances registered at the fourth network node, zero or one NF instance that has an NF instance ID of the first network node, and/or wherein the step of transmitting the fourth information may comprise: transmitting, to the second network node, a ninth message indicating zero or one NF instance, and/or wherein when one NF instance is determined and indicated by the ninth message, the ninth message may further indicate zero or more third features supported by the indicated NF instance as an NF service producer.

In some embodiments, at least one of following may be true: the first network node may be an SMF; the second network node may be a NEF or AF; the fourth network node may be an NRF; the second message may be an Nnrf_NFDiscovery_Request request message; the third message may be an Nnrf_NFDiscovery_Request response message; the fourth message may be an Nnrf_NFManagement_NFRegister request message; the seventh message may be an Nnrf_NFManagement_NFRegister request message; the eighth message may be an Nnrf_NFDiscovery_Request request message; and the ninth message may be an Nnrf_NFDiscovery_Request response message.

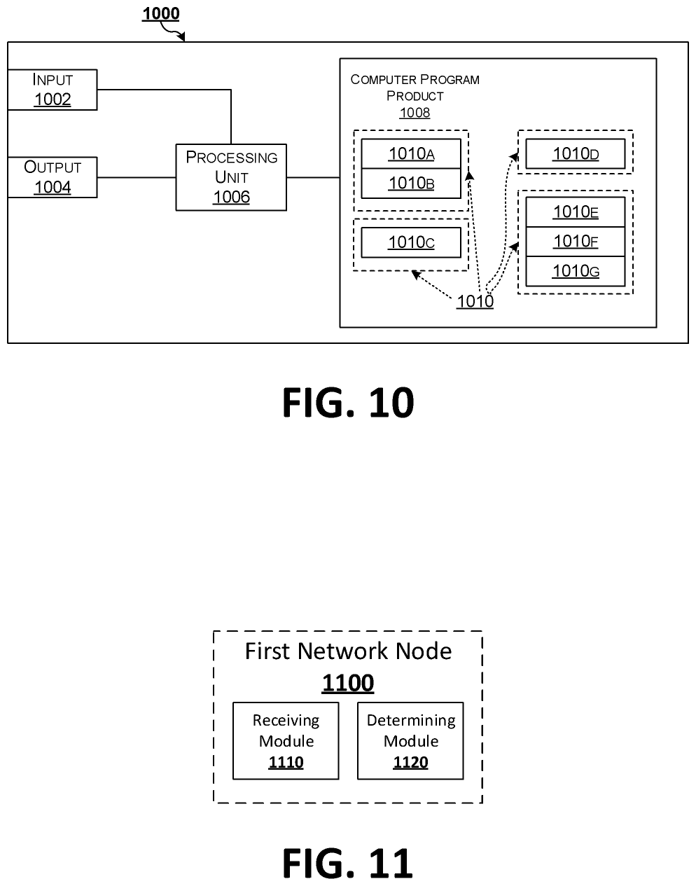

FIG. 10 schematically shows an embodiment of an arrangement which may be used in one or more network nodes (e.g., SMF, NEF/AF, PCF, and/or NRF) according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the network node(s) in which it is comprised to perform the actions, e.g., of the procedure described earlier in conjunction with FIG. 2A through FIG. 9 or any other variant.

The computer program 1010 may be configured as a computer program code structured in computer program modules 1010A and 1010B. Hence, in an exemplifying embodiment when the arrangement 1000 is used in a first network node for determining whether one or more first features are to be used for notification from the first network node to a second network node or not and the notification is subscribed by a non-direct subscription operation, the code in the computer program of the arrangement 1000 includes: a module 1010A configured to receive information indicating whether the one or more first features are supported by the second network node or information from which whether the one or more first features are supported by the second network node is able to be derived; and a module 1010B configured to determine whether the one or more first features are to be used for the notification based on at least the received information. In some embodiments, the first network node may comprise one or more further modules configured to perform one or more steps of any of the methods described with reference to FIG. 6.

Additionally or alternatively, the computer program 1010 may be configured as a computer program code structured in a computer program module 1010C. Hence, in an exemplifying embodiment when the arrangement 1000 is used in a second network node for facilitating a first network node in determining whether one or more first features are to be used for notification from the first network node to the second network node or not and the notification is subscribed by a non-direct subscription operation, the code in the computer program of the arrangement 1000 includes: a module 1010C configured to transmit, to a third network node different from the first network node, information indicating whether the one or more first features are supported by the second network node or information from which whether the one or more first features are supported by the second network node is able to be derived. In some embodiments, the second network node may comprise one or more further modules configured to perform one or more steps of any of the methods described with reference to FIG. 7.

Additionally or alternatively, the computer program 1010 may be configured as a computer program code structured in a computer program module 1010D. Hence, in an exemplifying embodiment when the arrangement 1000 is used in a third network node for facilitating a first network node in determining whether one or more first features are to be used for notification from the first network node to the second network node or not and the notification is subscribed by a non-direct subscription operation, the code in the computer program of the arrangement 1000 includes: a module 1010D configured to forward, from the second network node to the first network node, information indicating whether the one or more first features are supported by the second network node or information from which whether the one or more first features are supported by the second network node is able to be derived. In some embodiments, the third network node may comprise one or more further modules configured to perform one or more steps of any of the methods described with reference to FIG. 8.

Additionally or alternatively, the computer program 1010 may be configured as a computer program code structured in computer program modules 1010E, 1010F, and 1010G. Hence, in an exemplifying embodiment when the arrangement 1000 is used in a fourth network node for facilitating a first network node in determining whether one or more first features are to be used for notification from the first network node to the second network node or not and the notification is subscribed by a non-direct subscription operation, the code in the computer program of the arrangement 1000 includes: a module 1010E configured to receive, from the first network node, first information from which whether the one or more first features are supported by the second network node is able to be derived; a module 1010F configured to determine second information indicating whether the one or more first features are supported by the second network node based on at least the first information; and a module 1010G configured to transmit, to the first network node, the second information. In some embodiments, the fourth network node may comprise one or more further modules configured to perform one or more steps of any of the methods described with reference to FIG. 9.

The computer program modules could essentially perform the actions of the flow illustrated in FIG. 2A through FIG. 9, to emulate the network node(s). In other words, when the different computer program modules are executed in the processing unit 1006, they may correspond to different modules in the network node(s).

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor.

The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network node(s).

Correspondingly to the method 600 as described above, an exemplary first network node for determining whether one or more first features are to be used for notification from the first network node to a second network node or not is provided. In some embodiments, the notification may be subscribed by a non-direct subscription operation. FIG. 11 is a block diagram of a first network node 1100 according to an embodiment of the present disclosure. The first network node 1100 may be, e.g., the SMF 115 in some embodiments.

The first network node 1100 may be configured to perform the method 600 as described above in connection with FIG. 6. As shown in FIG. 11, the first network node 1100 may comprise a receiving module 1110 configured to receive information indicating whether the one or more first features are supported by the second network node or information from which whether the one or more first features are supported by the second network node is able to be derived; and a determining module 1120 configured to determine whether the one or more first features are to be used for the notification based on at least the received information.

The above modules 1110 and/or 1120 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the first network node 1100 may comprise one or more further modules, each of which may perform any of the steps of the method 600 described with reference to FIG. 6.

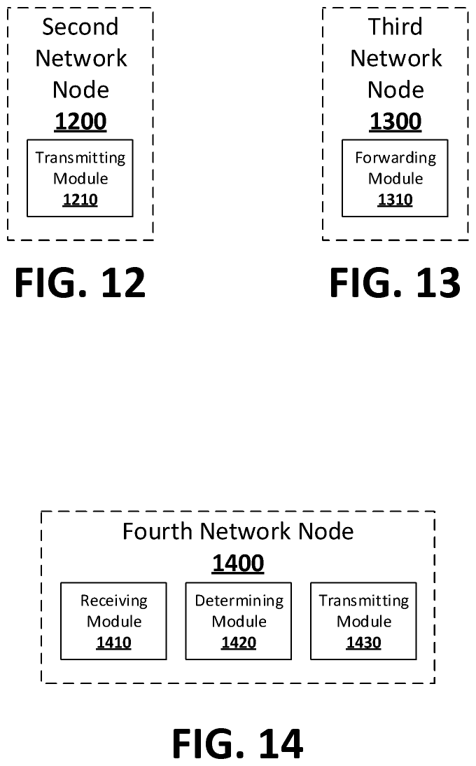

Correspondingly to the method 700 as described above, an exemplary second network node for facilitating a first network node in determining whether one or more first features are to be used for notification from the first network node to the second network node or not is provided. In some embodiments, the notification may be subscribed by a non-direct subscription operation. FIG. 12 is a block diagram of a second network node 1200 according to an embodiment of the present disclosure. The second network node 1200 may be, e.g., the NEF 145 or the AF 125 in some embodiments.

The second network node 1200 may be configured to perform the method 700 as described above in connection with FIG. 7. As shown in FIG. 12, the second network node 1200 may comprise a transmitting module 1210 configured to transmit, to a third network node different from the first network node, information indicating whether the one or more first features are supported by the second network node or information from which whether the one or more first features are supported by the second network node is able to be derived.

The above module 1210 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the second network node 1200 may comprise one or more further modules, each of which may perform any of the steps of the method 700 described with reference to FIG. 7.

Correspondingly to the method 800 as described above, an exemplary third network node for facilitating a first network node in determining whether one or more first features are to be used for notification from the first network node to a second network node or not is provided. In some embodiments, the notification may be subscribed by a non-direct subscription operation. FIG. 13 is a block diagram of a third network node 1300 according to an embodiment of the present disclosure. The third network node 1300 may be, e.g., the PCF 120 in some embodiments.

The third network node 1300 may be configured to perform the method 800 as described above in connection with FIG. 8. As shown in FIG. 13, the third network node 1300 may comprise a forwarding module 1310 configured to forward, from the second network node to the first network node, information indicating whether the one or more first features are supported by the second network node or information from which whether the one or more first features are supported by the second network node is able to be derived.

The above module 1310 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 8. Further, the third network node 1300 may comprise one or more further modules, each of which may perform any of the steps of the method 800 described with reference to FIG. 8.

Correspondingly to the method 900 as described above, an exemplary fourth network node for facilitating a first network node in determining whether one or more first features are to be used for notification from the first network node to a second network node or not is provided. In some embodiments, the notification may be subscribed by a non-direct subscription operation. FIG. 14 is a block diagram of a fourth network node 1400 according to an embodiment of the present disclosure. The fourth network node 1400 may be, e.g., the NRF 150 in some embodiments.

The fourth network node 1400 may be configured to perform the method 900 as described above in connection with FIG. 9. As shown in FIG. 14, the fourth network node 1400 may comprise a receiving module 1410 configured to receive, from the first network node, first information from which whether the one or more first features are supported by the second network node is able to be derived; a determining module 1420 configured to determine second information indicating whether the one or more first features are supported by the second network node based on at least the first information; and a transmitting module 1430 configured to transmit, to the first network node, the second information.

The above modules 1410, 1420, and/or 1430 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the fourth network node 1400 may comprise one or more further modules, each of which may perform any of the steps of the method 900 described with reference to FIG. 9.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

### APPENDIX A

### 3GPP TSG-CT WG3 Meeting #123e

E-Meeting, 18th-26th August 2022
Source: Ericsson
Title: Negotiation of supported features when subscription to notifications occurs via an indirect path
Document for: Discussion and agreement
Agenda Item: 17.xx (CT3)
Work Item/Release: eEDGE_5GC/Release 17
Abstract of the contribution:

Handling of supported features negotiation between peers in the scenarios of indirect subscription to notifications via an indirect path cannot be resolved using the mechanism defined in TS 29.500. CT3 has considered using NRF for that purpose. However, current specification of Nnrf services does not allow the discovery of the features supported for a specific NF instance when only the Notification URI associated to that instance is known. This paper proposes three solutions to resolve the issue with the purpose of agreeing on one of them for the introduction in the specifications.

### 1. Introduction

5G Core Networks allow that Service consumer NFs can explicitly or implicitly subscribe to be notified about data change to any type of resource. Implicit subscriptions are those that exist without being explicitly created by a dedicated subscribe operation (see TS 29.501, clause 4.6.2.2.1).

There are also other kind of subscriptions where the NF provider subscribes using a different service and a different path than the one used in the requested notification. Some examples of the subscription applicable to this case related to PCC functionality are shown here:
AF may send requests to influence SMF routing decisions for User Plane traffic of PDU Sessions as described in 3GPP TS 29.513, clause 5.5.3. In this case the AF uses the PCC framework (either directly via PCF or using the NEF & UDR when non targeting individual UE addresses) to indicate its subscriptions to SMF events, e.g. UP path change. SMF receives the subscription information provisioned in the PCC rule, i.e. the event and the AF/NEF notification URI. SMF will directly notify the AF (via NEF for external applications).
AF may provision service parameter data to the PCF that could generate URSP Rules towards the UE as described in 3GPP TS 29.513, clause 5.5.8. Additionally, the AF may subscribe to receive notifications on URSP Rules delivery outcome. The AF subscription is indicated to the PCF as service parameter data stored in the UDR, i.e., the service parameter data provisioned in UDR includes the event and the AF/NEF notification URI.

In these cases, the Network Function that requires to be notified needs to provide the event together with a Notification URI through the PCC framework. The Notification URI indicates the final receiver of the event notification.

It is also possible that the NF (service) consumer needs to initiate a new notification as a response to the notification generated as a consequence of an indirect subscription (i.e. callback of the received notification). In the first case described above (see e.g. TS 29.513, clause 5.5.3, step (4B, 4c)), the AF/NEF may need to interact with the SMF upon reception of the notification on UP path change to acknowledge that the application relocation is possible.

3GPP 5G CN supports a mechanism to negotiate applicable optional features for each 5G API. Both NF service consumer and NF service producer can directly negotiate the support of optional features as part of the interface, as specified in subclause 6.6 of 3GPP TS 29.500. This negotiation requires a direct interaction between the peers and takes place during the resource creation or resource data retrieval. Thus, for the scenarios described above, the Network Functions cannot make use of this mechanism since there has not been a direct communication for the negotiation of features.

3GPP 5G CN also supports a discovery mechanism that enable Core Network entities to discover a set of NF instance(s) and NF service instance(s) for a specific NF service or an NF type. NF service discovery is implemented via the Network Repository Function (NRF). NRF keeps information about the NF (service) profile for the NF (service) instances that have previously registered. Features supported by the NF (service) instance as NF service producer and as NF service consumer may be stored as part of the NF profile.

CT3 has already discussed feature negotiation of these specific cases in the context of Edge Computing, and concluded to use NRF so that the sender of notification/callback can discover the features supported by the receiver before initiating the notification. For example, in TS 29.513, clause 5.5.3.2, step 4e-4h:
Then the NEF notifies the SMF of the EAS IP replacement information as described in 3GPP TS 29.508 [8] if the NEF determines that the SMF supports the “EASIPreplacement” feature via the Nnrf_NFDiscovery service operation as defined in 3GPP TS 29.510 [51]. The AF may provide an indication that buffering of uplink traffic to the target DNAI is needed to the NEF. Then the NEF notifies the SMF of indication as described in 3GPP TS 29.508 [8] if the NEF determines that the SMF supports the “ULBuffering” feature via the Nnrf_NFDiscovery service operation as defined in 3GPP TS 29.510 [51].

The Network Functions in the CT3 scenarios described above are only aware of the Notification URI towards which the notification will be sent. NRF however cannot discover NF profiles associated to a Notification URI.

Thus, in order to fulfill the previously agreed approach some additional provisions may be needed in the NRF and/or in the PCC framework.

### 2. Discussion

### 2.1 General

In order for a Network Function to discover the features that another Network Function supports when:
it needs to initiate a notification towards that NF that has subscribed via an indirect path
it needs to initiate a notification (callback) towards that NF as a response to a previous notification that occurred based on a subscription via an indirect path different alternatives may exist:

Alternative A: Solution based on the registration of the Notification URI as part of the NF service profile in the NRF.

Alternative B: Solution based on the registration of an NF Instance Identifier as part of the NF service profile in the NRF.

Alternative C: Solution based on sending the list of supported features using the indirect path and notification request. No NRF is required.

### 2.2 Alternative A: Solution Based on NotificationUri

This solution considers that the Network Function that indirectly subscribes to receive direct notifications from a certain Network Function registers the Notification URI that is sent through the indirect path (PCC framework in CT3 scenarios) together with the features supported as NF service consumer. For the cases of callback of the received notification based on an indirect subscription, the Network Function that initiates the notification also registers as part of the NF profile the Notification URI.

In the scenario of AF influencing traffic routing, the AF/NEF registers in the NRF the same Notification URI that is sent via the PCF towards the SMF. When the SMF needs to initiate a notification towards the AF/NEF it will contact the NRF using the received Notification URI in order to obtain the supported features that the AF/NEF supports as NF Service Consumer.

Similarly, when the NEF/AF needs to interact with the SMF (callback of the received notification), the NEF/AF will contact the NRF using the received SMF Notification URI (not included in the existing NRF specified procedures) in order to obtain the supported features that the SMF supports as NF Service Producer.

2.3 Alternative B: Solution based on NfInstanceId

This solution is similar to the previous one, but is more straight forward as identifies the features supported by the real NF Instance Id that initiated the indirect subscription.

This solution considers that the Network Function that indirectly subscribes to receive direct notifications registers its NF instance Id together with the features it supports as NF service consumer. Additionally, the NF Instance Id should be sent all the way through the PCC framework from the notification receiver to the originator of the notification. The NF instance that initiates the notification based on the indirect subscription and expects a new notification from the receiver registers its NF profile for its NF Instance Id in the NRF together with the features it supports as NF service provider using the existing procedures.

In the scenario of AF influencing traffic routing, the AF/NEF registers in the NRF the same NF Instance Id it will send via the PCF towards the SMF together with the features it supports as NF service consumer. When the SMF needs to initiate a notification towards the AF/NEF it will contact the NRF using the received NF Instance Id in order to obtain the supported features that the AF/NEF supports as NF Service Consumer.

When the SMF expects further interactions from the NEF as consequence of the triggered notification, the SMF includes NF Instance Id together with the SMF notification URI in the notification request. When the AF/NEF needs to initiate the subsequent notification towards the SMF, it will contact the NRF using the received NF Instance Id in order to obtain the supported features of the SMF instance for the Nsmf_EventExposure service.

### 2.3 Alternative C: Solution Based on Sending Supported Features Via PCC

This solution considers that the Network Function that indirectly subscribes to receive direct notifications from another Network Function sends the list of supported features via the indirect path. In the scenario of AF influencing traffic routing, the AF/NEF will include the supported features in the interactions with the PCF, and/or UDR and are propagated to the SMF. The SMF can easily find out what features are supported by the NEF/AF based on this information, and can provide to the AF/NEF the negotiated features in the notification request.

This alternative can also be based on the definition of capabilities or functionalities instead of the current definition of features. Some attribute to convey this information can be provided as part of the distributed payload.

This solution does not require any interaction with the NRF.

### 2.4 Analysis

First and second alternatives are based on the same principles, although uses different information elements.

Alternative A requires the features supported by a NF service consumer/producer are associated to their respective Notification URI in the NRF. The Notification URI would also be used as query parameter during the discovery process.

Alternative B requires the introduction of the NF Instance Id in the different interfaces affected by the indirect subscription path so that the initiator of the notification can use it to query the NRF about the supported features. The NF Instance Id should also be added as part of the payload that the sender of the notification (that requires a callback to that notification request) will send, so that the receiver can use it to query the NRF to find out its supported features.

Alternative C does not have any impact in Nnrf services. Instead the service operations that convey the Notification URI using the indirect path would have to be modified to also introduce the features supported by the NF service consumer. In the callback scenarios, the sender of the notification that would require an additional callback would have to convey the negotiated supported features towards the receiver of the notification and originator of the callback. This alternative can be modified to convey “capabilities” or “functionalities” as specific data instead of the current definition of features.

Alternatives A & B go beyond CT3 remit and require a deep analysis from CT4 to check their viability. CT3 possible impacts would be considered once TS 29.510 is modified according to the final solution.

### 3. Conclusion

Three alternatives are presented in order to resolve the discovery of supported features between two peers when there is no direct supported feature negotiation.

It is proposed that CT3 discusses and agrees on a solution that better fits CT3 scenarios. If alternative A or B are considered as the preferred one(s), it is proposed to contact CT4 so that they analyse the impacts and introduce the required amendments in TS 29.510 as necessary before CT3 specifications are adapted accordingly.

Ericsson is happy to contribute according to the final agreed solution.

What is claimed is:

1. A method at a first network node for determining whether one or more first features are to be used for notification from the first network node to a second network node or not, the notification being subscribed by a non-direct subscription operation, the method comprising:
receiving information indicating whether the one or more first features are supported by the second network node or information from which whether the one or more first features are supported by the second network node is able to be derived; and
determining whether the one or more first features are to be used for the notification based on at least the received information.

2. The method of claim 1, wherein the non-direct subscription operation is a first service operation, which is associated with a first service and which is invoked by a third network node in response to a second service operation associated with a second service being invoked by the second network node,
wherein the first service is different from the second service,
wherein the third network node is different from the second network node; and
wherein at least one of the first service and the second service is provided by the third network node.

3. (canceled)

4. The method of claim 1, wherein the step of receiving the information comprises at least one of:
receiving, from the third network node, a first message indicating a notification Uniform Resource Identifier, which points to the second network node;
receiving, from the third network node, a first message indicating a network function (NF) instance identifier (ID) of the second network node; and
receiving, from the third network node, a first message indicating zero or more second features supported by the second network node as an NF service consumer.

5. The method of claim 1, wherein when the first message indicates the notification URI pointing to the second network node, the step of determining whether the one or more first features are to be used for the notification comprises:
transmitting, to a fourth network node, a second message for discovering an NF instance that has a notification URI in its NF profile matched with the notification URI and that supports, as an NF service consumer, the one or more first features required by the first network node; and/or
receiving, from the fourth network node, a third message indicating zero or one NF instance in response to the second message.

6. The method of claim 5, wherein the step of determining whether the one or more first features are to be used for the notification further comprises at least one of:
determining that the one or more first features are to be used for the notification at least in response to receiving, from the fourth network node, the third message indicating one NF instance and in response to determining that the one or more first features are one or more of zero or more second features that are indicated by the third message as being associated to a first notification type indicating that the notification is subscribed by a non-direct subscription operation; and
determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

7. The method of claim 5, wherein when the second message further indicates the first notification type, the step of determining whether the one or more first features are to be used for the notification further comprises at least one of:
determining that the one or more first features are to be used for the notification at least in response to receiving, from the fourth network node, the third message indicating one NF instance; and
determining that the one or more first features are not to be used for the notification at least in response to receiving, from the fourth network node, the third message indicating no NF instance.

8. The method of claim 1, wherein when the first message indicates the notification URI pointing to the second network node, the step of determining whether the one or more first features are to be used for the notification comprises:
transmitting, to a fourth network node, a second message for discovering an NF instance that has a notification URI in its NF profile matched with the notification URI; and/or
receiving, from the fourth network node, a third message indicating zero or one NF instance in response to the second message,
wherein when one NF instance is indicated by the third message, the third message further indicates, for the indicated NF instance and for each of notification types indicated by the third message, zero or more second features supported by the indicated NF instance as an NF service consumer.

9. The method of claim 8, wherein the step of determining whether the one or more first features are to be used for the notification further comprises at least one of:
determining that the one or more first features are to be used for the notification at least in response to receiving, from the fourth network node, the third message indicating one NF instance and in response to determining that the one or more first features are one or more of zero or more second features that are indicated by the third message as being associated to a first notification type, the first notification type indicating that the notification is subscribed by a non-direct subscription operation; and
determining that the one or more first features are not to be used for the notification at least in response to receiving, from the fourth network node, the third message indicating no NF instance or in response to, when the third message indicates one NF instance, determining that the one or more first features are not one or more of zero or more second features that are indicated by the third message as being associated to the first notification type.

10. The method of claim 1, wherein when the first message indicates the notification URI pointing to the second network node, the step of determining whether the one or more first features are to be used for the notification comprises:
transmitting, to a fourth network node, a second message for discovering an NF instance that has a notification URI in its NF profile matched with the notification URI and associated to a first notification type, the first notification type indicating that the notification is subscribed by a non-direct subscription operation; and/or
receiving, from the fourth network node, a third message indicating zero or one NF instance in response to the second message,
wherein when one NF instance is indicated by the third message, the third message further indicates, for the indicated NF instance and for the first notification type, zero or more second features supported by the indicated NF instance as an NF service consumer.

11. The method of claim 10, wherein the step of determining whether the one or more first features are to be used for the notification further comprises at least one of:
determining that the one or more first features are to be used for the notification at least in response to receiving, from the fourth network node, the third message indicating one NF instance and in response to determining that the one or more first features are one or more of the zero or more second features; and
determining that the one or more first features are not to be used for the notification at least in response to receiving, from the fourth network node, the third message indicating no NF instance or in response to, when the third message indicates one NF instance, determining that the one or more first features are not one or more of the zero or more second features.

12. The method of claim 1, wherein when the first message indicates the NF instance ID of the second network node, the step of determining whether the one or more first features are to be used for the notification comprises:
transmitting, to a fourth network node, a second message for discovering an NF instance that has an NF instance ID indicated in the first message and that supports, as an NF service consumer, the one or more first features required by the first network node; and/or
receiving, from the fourth network node, a third message indicating zero or one NF instance in response to the second message.

13. (canceled)

14. The method of claim 1, wherein when the first message indicates the NF instance ID of the second network node, the step of determining whether the one or more first features are to be used for the notification comprises:
transmitting, to a fourth network node, a second message for discovering an NF instance that has an NF instance ID indicated in the first message; and/or
receiving, from the fourth network node, a third message indicating zero or one NF instance in response to the second message,
wherein when one NF instance is indicated by the third message, the third message further indicates, for the indicated NF instance and for each of notification types indicated by the third message, zero or more second features supported by the indicated NF instance as an NF service consumer.

15. (canceled)

16. The method of claim 1, wherein when the first message indicates the zero or more second features supported by the second network node as an NF service consumer, the step of determining whether the one or more first features are to be used for the notification comprises at least one of:
determining that the one or more first features are to be used for the notification at least in response to determining that the zero or more second features supported by the second network node comprise the one or more first features; and
determining that the one or more first features are not to be used for the notification at least in response to determining that the zero or more second features supported by the second network node do not comprise the one or more first features.

17. (canceled)

18. The method of claim 1, further comprising:
transmitting, to the second network node, a fifth message as the notification, with the one or more first features used based on at least the determination of whether the one or more first features are to be used for the notification.

19. The method of claim 18, wherein the fifth message further indicates at least one of:
a notification URI pointing to the first network node;
an NF instance ID of the first network node; and
zero or more third features supported by the first network node as an NF service producer.

20. (canceled)

21. A first network node, comprising:
a processor;
a memory storing instructions which, when executed by the processor, cause the processor to perform the method of claim 1.

22. (canceled)

23. A method at a second network node for facilitating a first network node in determining whether one or more first features are to be used for notification from the first network node to the second network node or not, the notification being subscribed by a non-direct subscription operation, the method comprising:
transmitting, to a third network node different from the first network node, information indicating whether the one or more first features are supported by the second network node or information from which whether the one or more first features are supported by the second network node is able to be derived.

24. The method of claim 23, wherein the non-direct subscription operation is a first service operation, which is associated with a first service and which is invoked by the third network node in response to a second service operation associated with a second service being invoked by the second network node,
wherein the first service is different from the second service,
wherein the third network node is different from the second network node; and
wherein at least one of the first service and the second service is provided by the third network node.

25. (canceled)

26. The method of claim 23, wherein the step of transmitting the information comprises at least one of:
transmitting, to the third network node, a sixth message indicating a notification URI, which points to the second network node;
transmitting, to the third network node, a sixth message indicating an NF instance ID of the second network node; and
transmitting, to the third network node, a sixth message indicating zero or more second features supported by the second network node as an NF service consumer.

27. (canceled)

28. The method of claim 23, further comprising:
receiving, from the first network node, a fifth message as the notification, with the one or more first features used based on at least the information transmitted to the third network node.

29.-74. (canceled)
